(19) United States
(12) Patent Application Publication
(10) Pub. No.: US 2020/0217525 A1
(43) Pub. Date: Jul. 9, 2020

(54) HUMIDITY CONTROL DEVICE

(71) Applicant: DENSO CORPORATION, Kariya-city (JP)

(72) Inventors: Kenichiro MAEDA, Kariya-city (JP); Yusuke KOMATSUBARA, Kariya-city (JP)

(21) Appl. No.: 16/821,754

(22) Filed: Mar. 17, 2020

Related U.S. Application Data
(63) Continuation of application No. PCT/JP2018/031220, filed on Aug. 23, 2018.

(30) Foreign Application Priority Data
Oct. 5, 2017 (JP) 2017-194961

(51) Int. Cl. F24F 3/14; B01D 53/06

(52) U.S. Cl. CPC F24F 3/1411; B01D 53/06; F24F 2003/1458; B01D 2259/4009; B01D 2253/202; B01D 2257/80; B01D 2253/108

(57) ABSTRACT

A humidity control device includes an adsorber, a blower, and a mode switching unit configured to set a desorption mode in which moisture adsorbed by an adsorbent is desorbed to humidify air or an adsorption mode in which moisture is adsorbed by the adsorbent to dehumidify air. The adsorber has ventilation surfaces through which air flows in or out. The mode switching unit is configured to reverse an air flow direction in the adsorber such that one of the ventilation surfaces serving as an air inflow surface in the adsorption mode is used for an air outflow surface in the desorption mode and that the other of the ventilation surfaces serving as an air outflow surface in the adsorption mode becomes an air inflow surface in the desorption mode in a state where an air suction direction and an air blowout direction of the blower is maintained.

### CROSS REFERENCE TO RELATED APPLICATION

The present application is a continuation application of International Patent Application No. PCT/JP2018/031220 filed on Aug. 23, 2018, which designated the U.S. and claims the benefit of priority from Japanese Patent Application No. 2017-194961 filed on Oct. 5, 2017. The entire disclosures of all of the above applications are incorporated herein by reference.

### TECHNICAL FIELD

The present disclosure relates to a humidity control device that controls a humidity of a target space by using moisture adsorption and desorption action of an adsorbent.

### BACKGROUND

A humidifying device alternately performs an adsorption mode and a desorption mode. In the adsorption mode, cool air is introduced into an adsorber having an adsorbent to adsorb moisture contained in the cold air to the adsorbent. In the desorption mode, warm air is introduced into the adsorbent to desorb moisture adsorbed by the adsorbent.

### SUMMARY

According to one aspect of the present disclosure, a humidity control device includes: an adsorber including an adsorbent; a blower for supplying air to the adsorber; and a mode switching unit that switches between a desorption mode in which moisture adsorbed by the adsorbent is desorbed to humidify the air and an adsorption mode in which moisture is adsorbed by the adsorbent to dehumidify the air. The adsorber has a pair of ventilation surfaces through which air flows in or out. The mode switching unit is configured to reverse an air flow direction in the adsorber such that one of the pair of ventilation surfaces serving as an air inflow surface in the adsorption mode is used for an air outflow surface in the desorption mode and that the other of the pair of ventilation surfaces serving as an air outflow surface in the adsorption mode becomes an air inflow surface in the desorption mode in a state where an air suction direction and an air blowout direction of the blower is maintained.

### BRIEF DESCRIPTION OF DRAWINGS

FIG. 1 is a schematic configuration diagram of an air conditioner according to a first embodiment.

FIG. 2 is an explanatory diagram illustrating an operation by the air conditioner in an adsorption mode of the first embodiment.

FIG. 3 is an explanatory diagram for explaining a distribution of moisture inside an adsorber in an adsorption mode.

FIG. 4 is an explanatory diagram for explaining inside of the adsorber in a desorption mode in a configuration in which a ventilation direction inside the adsorber is the same between the adsorption mode and the desorption mode.

FIG. 5 is an explanatory diagram for explaining an operation by the air conditioner in a desorption mode of the first embodiment.

FIG. 6 is an explanatory diagram illustrating inside of the adsorber in the air conditioner of the first embodiment in a desorption mode.

FIG. 7 is a schematic configuration diagram illustrating a modification of the air conditioner of the first embodiment.

FIG. 8 is a schematic configuration diagram of an air conditioner according to a second embodiment.

FIG. 9 is an explanatory diagram for explaining an operation by the air conditioner in an adsorption mode of the second embodiment.

FIG. 10 is an explanatory diagram illustrating an operation by the air conditioner in a desorption mode of the second embodiment.

FIG. 11 is a schematic configuration diagram illustrating a modification of the air conditioner of the second embodiment.

FIG. 12 is a schematic configuration diagram of an air conditioner according to a third embodiment.

FIG. 13 is an explanatory diagram for explaining an operation by the air conditioner in an adsorption mode of the third embodiment.

FIG. 14 is an explanatory diagram illustrating inside of an adsorber of the air conditioner in an adsorption mode of the third embodiment.

FIG. 15 is an explanatory diagram illustrating an operation by the air conditioner in a desorption mode of the third embodiment.

FIG. 16 is an explanatory diagram illustrating inside of an adsorber of the air conditioner in a desorption mode of the third embodiment.

FIG. 17 is a schematic configuration diagram of an air conditioner according to a fourth embodiment.

FIG. 18 is an explanatory diagram illustrating an operation by the air conditioner of the fourth embodiment.

FIG. 19 is an explanatory diagram for explaining an operation of the adsorber in the air conditioner of the fourth embodiment.

FIG. 20 is a schematic configuration diagram of an air conditioner according to a fifth embodiment.

FIG. 21 is a schematic diagram illustrating an upper surface side of an adsorber of the air conditioner of the fifth embodiment.

FIG. 22 is an explanatory diagram for explaining an operation of the adsorber in the air conditioner of the fifth embodiment.

### DETAILED DESCRIPTION OF EMBODIMENTS

To begin with, examples of relevant techniques will be described.

A humidifying device alternately performs an adsorption mode and a desorption mode. In the adsorption mode, cool air is introduced into an adsorber having an adsorbent to adsorb moisture contained in the cool air to the adsorbent. In the desorption mode, warm air is introduced into the adsorber to desorb moisture adsorbed by the adsorbent. The humidifying device is configured to reverse the air flow direction inside the adsorber by reversing the air suction direction and the air blowout direction of the blower between the adsorption mode and the desorption mode.

The present inventors studied the distribution of moisture in the adsorber when the humidity control device was operated in developing a humidity control device such as a humidifier. As a result, the moisture adsorbed by the adsorbent in the adsorption mode is not uniformly distributed inside the adsorber, and tends to be concentrated on the air inflow surface rather than the air outflow surface of the pair of ventilation surfaces in the adsorber.

In the configuration in which the flow direction of air inside the adsorber is the same between the adsorption mode and the desorption mode, moisture is unevenly distributed on one ventilation surface side of the adsorber in the adsorption mode. In this state, when air for desorbing moisture is introduced from the one ventilation surface side in the desorption mode, the moisture desorbed from the adsorbent on the one ventilation surface side is adsorbed on the other ventilation surface side. Therefore, the humidifying function of the humidity control device cannot be properly exhibited.

It is conceivable to adopt a configuration in which the suction direction and the blowout direction can be reversed as the blower, so as to reverse the air flow direction inside the adsorber. However, the flexibility for selecting the blower is significantly limited.

The present disclosure provides a humidity control device capable of appropriately controlling a humidity while securing a flexibility in selecting a blower.

The present disclosure is related to a humidity control device that adjusts the humidity of a target space by using adsorption and desorption of moisture by an adsorbent.

According to one aspect of the present disclosure, a humidity control device includes:

an adsorber including an adsorbent;

a blower for supplying air to the adsorber; and

a mode switching unit that switches between a desorption mode in which moisture adsorbed by the adsorbent is desorbed to humidify the air and an adsorption mode in which moisture is adsorbed by the adsorbent to dehumidify the air.

The adsorber has a pair of ventilation surfaces through which air flows in or out.

The mode switching unit is configured to reverse an air flow direction in the adsorber such that one of the pair of ventilation surfaces serving as an air inflow surface in the adsorption mode is used for an air outflow surface in the desorption mode and that the other of the pair of ventilation surfaces serving as an air outflow surface in the adsorption mode becomes an air inflow surface in the desorption mode in a state where an air suction direction and an air blowout direction of the blower is maintained.

Accordingly, even if moisture is unevenly distributed on one ventilation surface of the adsorber in the adsorption mode, the air flowing out from the one ventilation surface in the desorption mode receives the unevenly-distributed moisture. Therefore, it becomes difficult for the air that has received the moisture to be adsorbed by the adsorbent again. As a result, the humidifying function of the humidity control device can be properly exhibited.

In particular, in the configuration in which the air flow direction in the adsorber is reversed by the mode switching unit, there is no need to employ a blower that can reverse the air suction direction and the air blowout direction, so the flexibility in selecting the blower is ensured.

According to another aspect of the present disclosure, a humidity control device includes:

an adsorber including the adsorbent;

a blower configured to supply air to the adsorber;

a casing housing the blower and the adsorber and having an air passage communicated with a ventilation path inside the adsorber; and

an adsorber displacement mechanism configured to displace the adsorber.

A part of the air passage is partitioned into a cool air passage through which cool air flows and a warm air passage through which warm air flows.

The adsorber has a pair of ventilation surfaces through which air flows in or out, and is arranged so that the pair of ventilation surfaces straddle both the cool air passage and the warm air passage.

The adsorber displacement mechanism is configured to displace the adsorber to a position where cool air and warm air flowing in from one of the ventilation surfaces flow out from the other of the ventilation surfaces and where cool air and warm air flowing in from the other of the ventilation surfaces flow out of the one of the ventilation surfaces.

Accordingly, it is possible to reverse the flow direction of the cool air and the flow direction of the warm air in the ventilation path of the adsorber without reversing the air suction direction and the air blowout direction in the blower. For this reason, even if moisture is unevenly distributed on the one ventilation surface of the adsorber, the humidification function of the humidity control device can be appropriately exhibited by switching the one ventilation surface to the air outflow surface.

In addition, since the adsorber is arranged so as to straddle both the cool air passage and the warm air passage, it is possible to simultaneously generate dehumidified air and humidified air by the moisture adsorption and desorption by the adsorbent.

According to another aspect of the present disclosure, the humidity control device includes:

an adsorber including an adsorbent;

a blower configured to supply air to the adsorber; and

a casing housing the blower and the adsorber and haviing an air passage communicated with a ventilation path inside the adsorber.

A part of the air passage is partitioned into a cool air passage through which cool air flows and a warm air passage through which warm air flows.

The adsorber has a pair of ventilation surfaces through which air flows in or out, and

the pair of ventilation surfaces are arranged across both the cool air passage and the warm air passage so that a part of one of the ventilation surfaces becomes a cool air inflow surface and the rest of the one of the ventilation surfaces becomes a warm air outflow surface, and a part of the other ventilation surface becomes a cool air outflow surface and the rest of the other ventilation surface becomes a warm air inflow surface.

Accordingly, even if moisture is unevenly distributed on one ventilation surface side, the moisture is used for humidifying the air flowing out from the one ventilation surface. For this reason, the humidification function in the humidity control device can be appropriately exerted without reversing the air suction direction and the air blowout direction in the blower.

In addition, since the adsorber is disposed so as to straddle both the cool air passage and the warm air passage, it is possible to simultaneously generate dehumidified air in which moisture is adsorbed by the adsorbent and humidified air humidified by the moisture of the adsorbent.

Therefore, according to the humidity control device of the present disclosure, it is possible to appropriately exert the humidity adjustment function of the humidity control device while securing the flexibility in selecting a blower.

Embodiments of the present disclosure will be described below with reference to the drawings. In the following embodiments, portions that are the same as or equivalent to those described in the preceding embodiments are denoted by the same reference numerals, and a description of the same or equivalent portions may be omitted. In addition, when only a part of the components is described in the embodiment, the components described in the preceding embodiment can be applied to other parts of the components. In the following embodiments, the embodiments can be partially combined with each other as long as the embodiments do not cause any trouble in combination, even if the combination is not specified in particular.

### First Embodiment

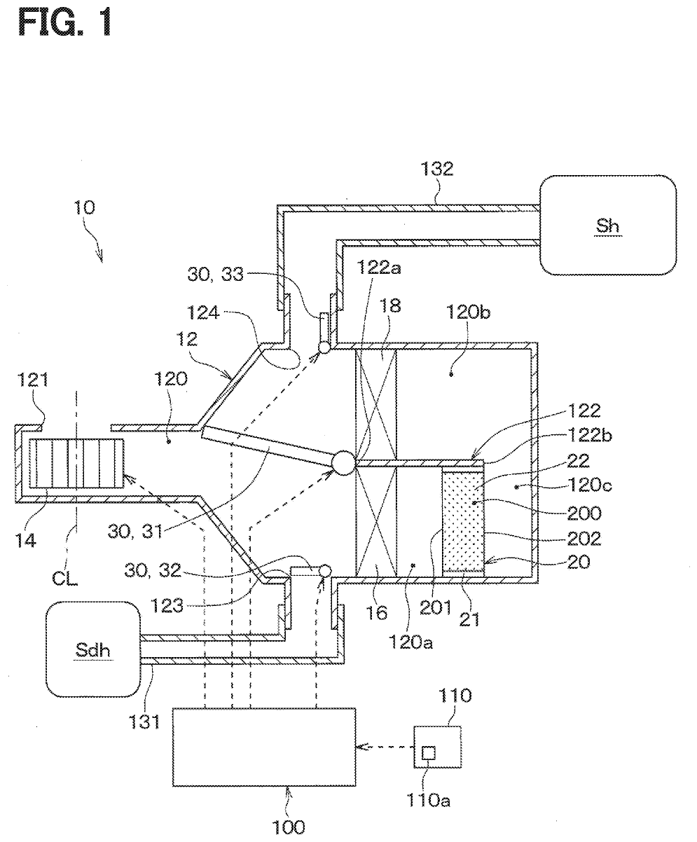

The present embodiment will be described with reference to FIGS. 1 to 6. In the present embodiment, a humidity control device of the present disclosure is applied to an air conditioner 10 that controls the humidity inside a house or a vehicle. The air conditioner 10 of the present embodiment is used as a non-water supply humidifier that provides a humidified air generated by an adsorber 20 to a space Sdh around a user without supplying water from the outside. In the present embodiment, the space Sdh around the user in a room corresponds to a target space of the humidity control.

As shown in FIG. 1, the air conditioner 10 includes a casing 12 that forms an air passage 120 that guides air into the room. The casing 12 has an air introduction part 121 for introducing air into the air passage 120 at the most upstream side of the air flow.

The casing 12 houses a blower 14 for generating an airflow toward the room in the air passage 120, a cooler 16 for cooling the air to generate cool air, a heater 18 for heating the air to generate warm air, an adsorber 20, a path switching mechanism 30, and the like.

The blower 14 is a device that supplies the air sucked from the air introduction part 121 to the cooler 16, the heater 18, and the adsorber 20. The blower 14 of the present embodiment has a structure in which the air suction direction and the air blowout direction are fixed in predetermined directions. Specifically, the blower 14 is configured as a centrifugal blower that blows out air sucked along an axis CL that is a rotation center of the blower 14 in a direction crossing the axis CL.

The cooler 16 cools the air blown from the blower 14 to generate cool air. In the present embodiment, an evaporator constituting a vapor compression refrigeration cycle is employed as the cooler 16.

The heater 18 heats the air blown from the blower 14 to generate warm air. In the present embodiment, a heater core that emits heat of cooling water of a heat-generating device (for example, an internal combustion engine) is employed as the heater 18.

Here, the cooler 16 and the heater 18 are arranged in the air passage 120 on the downstream side of the blower 14 in the air flow. The cooler 16 and the heater 18 are arranged in parallel with the air flow of the blower 14.

The casing 12 of the present embodiment has a partition 122 that partitions the air passage 120 into a cooler passage 120a in which the cooler 16 is installed and a heater passage 120b in which the heater 18 is installed.

A path switching door 31 of the path switching mechanism 30, which will be described later, is provided on one end portion 122a of the partition 122 near the blower 14. A communication passage 120c that connects the cooler passage 120a and the heater passage 120b is provided on the other end portion 122b of the partition 122 opposite to the one end portion 122a.

Further, the casing 12 has a humidification-side opening 123 for leading the humidified air to the outside of the casing 12 and a dehumidification-side opening 124 for leading the dehumidified air to the outside of the casing 12.

The humidification-side opening 123 opens in a portion of the casing 12 between the blower 14 and the cooler 16. Specifically, the humidification side opening 123 is opened at a position in the casing 12 where the path switching door 31 is on the downstream side of the cooler 16 in the air flow when a side of the cooler passage 120a facing the blower 14 is closed. The humidification-side opening 123 is connected to a humidification-side duct 131 for guiding the humidified air to the space Sdh around the user.

The dehumidification-side opening 124 is opened at a portion of the casing 12 between the blower 14 and the heater 18. Specifically, the dehumidification-side opening 124 opens at a position in the casing 12 where the path switching door 31 is on the downstream side of the heater 18 in the air flow when a side of the heater passage 120b facing the blower 14 is closed. The dehumidification-side opening 124 is connected to a dehumidification-side duct 132 for discharging dehumidified air to an outdoor space Sh different from the space Sdh around the user.

The adsorber 20 is configured such that a ventilation path 200 through which air can flow is formed therein, and that the moisture contained in the air passing through the ventilation path 200 can be adsorbed and desorbed. The adsorber 20 of the present embodiment is fixed inside the casing 12 so that its position does not change. Specifically, the adsorber 20 is disposed at a position between the cooler 16 and the communication passage 120c in the cooler passage 120a. The adsorber 20 may be disposed at a position between the heater 18 and the communication passage 120c in the heater passage 120b or at the communication passage 120c.

The adsorber 20 has a side wall 21 that forms an outer shell, and an adsorbent 22 is provided on the side wall 21. Further, the adsorber 20 has a pair of ventilation surfaces 201 and 202 through which air flows in or out. The pair of ventilation surfaces 201 and 202 are formed at both ends of the side wall 21.

The side wall 21 forms the ventilation path 200 therein. The pair of ventilation surfaces 201 and 202 through which air flows in or out of the ventilation path 200 of the adsorber 20 are formed at both ends of the side wall 21. Note that the side wall 21 has a thickness with which a high gas barrier property is exhibited so that air does not permeate from portions other than the pair of ventilation surfaces 201 and 202.

The adsorbent 22 is provided inside the side wall 21. The adsorbent 22 is formed integrally with the side wall 21. The adsorbent 22 is configured to include a base material having an adsorption substance carried on the surface. The adsorbent 22 has air permeability. That is, as the adsorbent 22, a base material on which the adsorption substance is supported is arranged so that air can flow.

Here, the adsorption substance has a property of adsorbing moisture in the air or desorbing the adsorbed moisture to humidify the air. As the adsorbent, a polymer adsorbent, zeolite, silica gel, or the like is used.

In the adsorber 20, when the relative humidity of the air passing through the ventilation path 200 inside the adsorber 20 is relatively high, the moisture contained in the air is adsorbed by the adsorbent 22. Therefore, when air having a relatively high relative humidity is supplied to the adsorber 20, the air is dehumidified by the adsorbent 22, and flows out of the adsorber 20 as dehumidified air.

Further, in the adsorber 20, when the relative humidity of the air passing through the ventilation path 200 inside the adsorber 20 is low to some extent, the water adsorbed by the adsorbent 22 is desorbed. For this reason, when air having a relatively low relative humidity is supplied to the adsorber 20, the air is humidified by the adsorbent 22, and flows out of the adsorber 20 as humidified air.

The path switching mechanism 30 has a desorption mode in which moisture adsorbed by the adsorbent 22 is desorbed to humidify the air, and an adsorption mode in which moisture is adsorbed by the adsorbent 22 to dehumidify the air. The path switching mechanism 30 switches the ventilation path of the air flowing through the air passage 120 inside the casing 12 between the desorption mode and the adsorption mode. The path switching mechanism 30 functions as a mode switching unit that switches the path of air between the desorption mode and the adsorption mode.

The path switching mechanism 30 of the present embodiment is configured to reverse the direction of air flow in the adsorber 20 between the adsorption mode and the desorption mode. Specifically, the path switching mechanism 30 includes the path switching door 31, a first opening/closing door 32, and a second opening/closing door 33. Each of the doors 31 to 33 is constituted by a turning door which is turned by an electric actuator (not shown). Each of the doors 31 to 33 is not limited to a pivoting door, and may be, for example, a sliding door.

The path switching door 31 is disposed between the blower 14 and the partition 122. The path switching door 31 selectively opens and closes the cooler passage 120a and the heater passage 120b, on the side facing the blower 14.

In the adsoption mode, the path switching door 31 is set at a position that opens the cooler passage 120a and closes the heater passage 120b. Thus, in the adsorption mode, a cool air generated by the cooler 16 flows into the adsorber 20 from one of the ventilation surfaces 201 and flows out from the other ventilation surface 202.

The path switching door 31 is set to a position that opens the heater passage 120b and closes the cooler passage 120a in the desorption mode.

Thereby, in the desorption mode, the warm air generated by the heater 18 flows into the adsorber 20 from the other ventilation surface 202 and flows out from the one ventilation surface 201.

The first opening/closing door 32 opens and closes the humidification-side opening 123. The first opening/closing door 32 is set to a position to close the humidification-side opening 123 in the adsorption mode, and to a position to open the humidification-side opening 123 in the desorption mode.

The second opening/closing door 33 opens and closes the dehumidification-side opening 124. The second opening/closing door 33 is set to a position to open the dehumidification-side opening 124 in the adsorption mode, and to a position to close the dehumidification-side opening 124 in the desorption mode.

The operation of the path switching mechanism 30 configured as described above is controlled by the control device 100. The control device 100 is an electric control unit that controls various devices such as the blower 14 and the path switching mechanism 30 in the air conditioner 10. The control device 100 includes a well-known microcomputer including a processor, a memory, and the like, and its peripheral circuits. The control device 100 executes various processes according to a program stored in the memory. Note that the memory is configured by a non-transitory tangible storage medium.

An operation panel 110 is connected to an input side of the control device 100. The operation panel 110 has a humidity control switch 110a for switching the humidity control operation of the air conditioner 10 on and off.

The operation of the air conditioner 10 of the present embodiment will be described. When the humidity control switch 110a is turned on, the air conditioner 10 performs a humidity adjustment operation for humidifying the space Sdh around the occupant.

In the humidity adjustment operation of the present embodiment, the control device 100 operates the blower 14. In this state, the control device 100 switches the ventilation path by the path switching mechanism 30 at a predetermined time, so that the adsorption mode and the desorption mode are alternately repeated. The switching of the ventilation path by the path switching mechanism 30 may be performed according to, for example, the amount of water inside the adsorber 20 instead of the time.

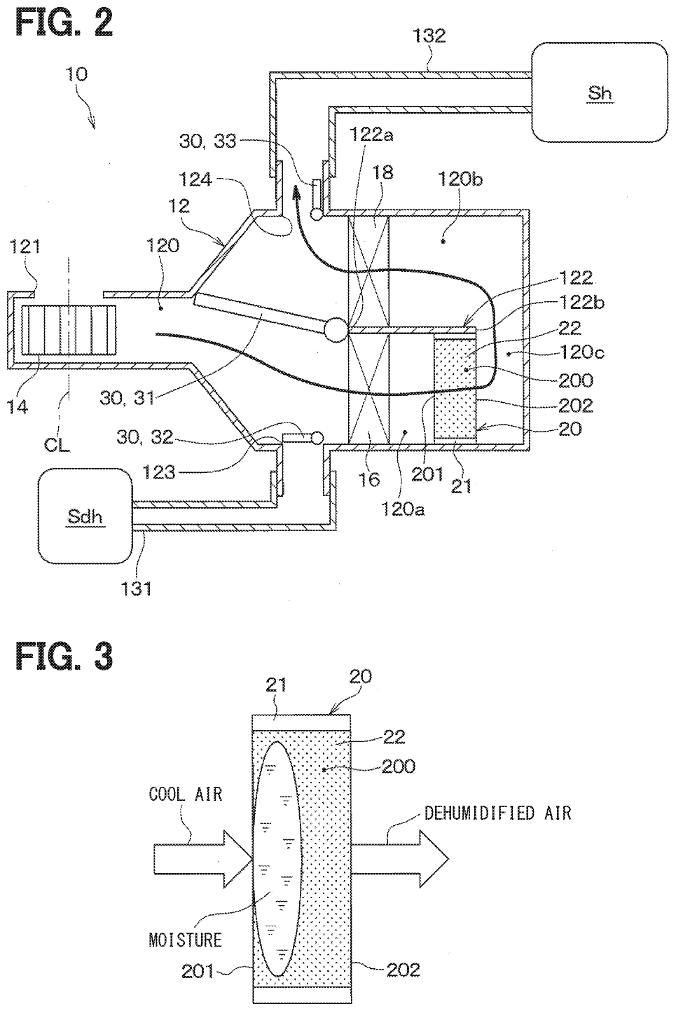

In the adsorption mode, the path switching door 31, the first opening/closing door 32, and the second opening/closing door 33 constituting the path switching mechanism 30 are controlled to predetermined positions by the control device 100. Specifically, as shown in FIG. 2, the path switching door 31 is set to a position that opens the cooler passage 120a and closes the heater passage 120b in the adsorption mode. The first opening/closing door 32 is set at a position for closing the humidification-side opening 123 in the adsorption mode. Further, the second opening/closing door 33 is set at a position to open the dehumidification-side opening 124 in the adsorption mode.

Thereby, in the adsorption mode, the air blown from the blower 14 flows into the cooler 16. The air that has flowed into the cooler 16 is cooled by the cooler 16, so that the relative humidity is increased to a high humidity at which moisture can be adsorbed by the adsorber 20.

The low-temperature and high-humidity air cooled by the cooler 16 flows into the adsorber 20 from the one ventilation surface 201. The low-temperature and high-humidity air that has flowed into the adsorber 20 is dehumidified by adsorbing moisture by the adsorbent 22 when passing through the ventilation path 200 inside the adsorber 20, and then flow out of the other ventilation surface 202 of the adsorber 20.

The low-temperature and low-humidity air dehumidified by the adsorber 20 flows into the heater 18 via the communication passage 120c. The air that has flowed into the heater 18 is heated when passing through the heater 18 to be dehumidified air at an appropriate temperature, and is passed through the dehumidification-side opening 124 and the dehumidification-side duct 132 outside the space Sdh around the occupant. The air is exhausted to the outdoor space Sh.

According to the investigation and research by the present inventors, the moisture adsorbed by the adsorbent 22 in the adsorption mode is not uniformly distributed inside the adsorber 20, but tends to be unevenly distributed in a part of the adsorber 20. Specifically, the moisture adsorbed by the adsorbent 22 in the adsorption mode tends to be biased to, as shown in FIG. 3, one of the pair of ventilation surfaces 201 and 202 of the adsorber 20, that is, on the side of the one ventilation surface 201 serving as an air inflow surface.

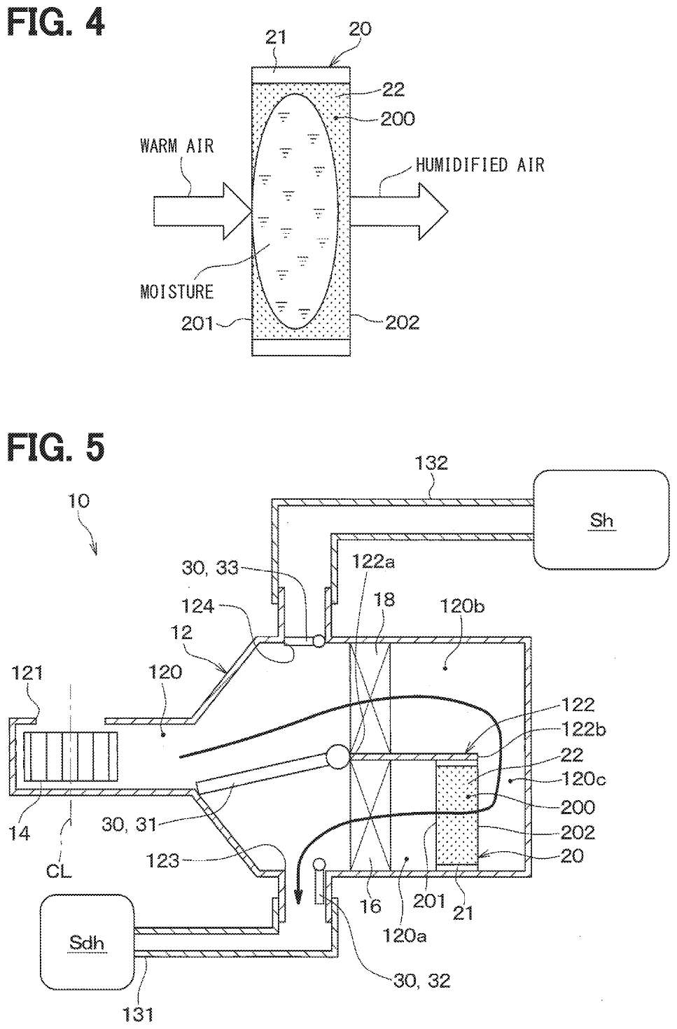

In the configuration in which the ventilation direction inside the adsorber 20 is the same direction in the adsorption mode and the desorption mode, the water adsorbed by the adsorbent 22 is desorbed on the one ventilation surface 201 where the water is unevenly distributed. In this case, as shown in FIG. 4, the moisture desorbed from the adsorbent 22 on the one ventilation surface 201 side is adsorbed by the adsorbent 22 on the other ventilation surface 202 side, so that the air is not sufficiently humidified and flows out from the other ventilation surface 202.

It may be possible to uniformly distribute moisture inside the adsorber 20 by extending the duration of the adsorption mode. However, in this case, the period during which no humidified air is generated becomes longer.

As described above, in the configuration in which the ventilation direction inside the adsorber 20 is the same in the adsorption mode and the desorption mode, if moisture is unevenly distributed on the one ventilation surface 201 of the adsorber 20 in the adsorption mode, the air conditioning is stopped. There is a possibility that the humidifying function of the air conditioner 10 may not be properly performed.

Therefore, the air conditioner 10 of the present disclosure has a configuration in which the path switching mechanism 30 reverses the ventilation direction of the air in the adsorber 20 between the adsorption mode and the desorption mode. Specifically, as shown in FIG. 5, the path switching door 31 is set at a position where the heater passage 120b is opened and the cooler passage 120a is closed in the desorption mode. The first opening/closing door 32 is set at a position where the humidification-side opening 123 is opened in the desorption mode. In addition, the second opening/closing door 33 is set to a position that closes the dehumidification-side opening 124 in the desorption mode.

Thereby, in the desorption mode, the air blown from the blower 14 flows into the heater 18. The air that has flowed into the heater 18 is heated by the heater 18, so that the relative humidity is reduced to a low humidity at which moisture can be desorbed from the adsorber 20.

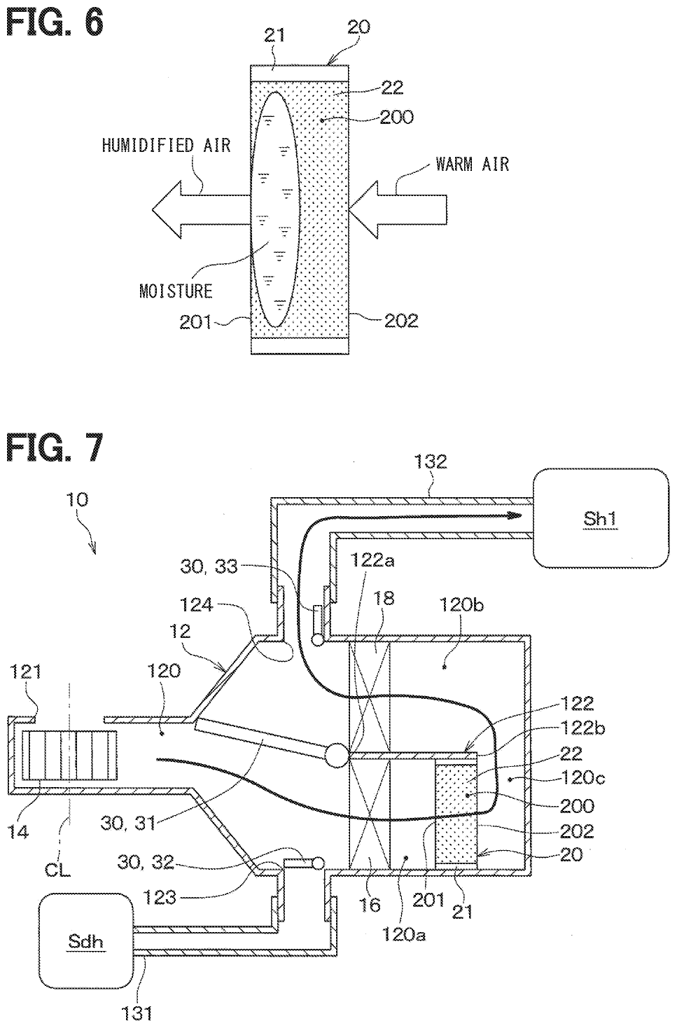

The high-temperature and low-humidity air heated by the heater 18 flows into the adsorber 20 from the other ventilation surface 202. The high-temperature and low-humidity air that has flowed into the adsorber 20 is humidified by moisture released from the adsorbent 22 when passing through the ventilation path 200 inside the adsorber 20, and then flows out from the one ventilation surface 201 of the adsorber 20. At this time, since the air flowing out of the one ventilation surface 201 receives the water biased to the one ventilation surface 201 of the adsorber 20, as shown in FIG. 6, the air receiving the water inside the adsorber 20 becomes high-temperature and high-humidity humidified air without being adsorbed by the adsorbent 22 again.

The high-temperature and high-humidity air humidified by the adsorber 20 flows into the cooler 16 via the communication passage 120c. The air that has flowed into the cooler 16 is cooled when passing through the cooler 16 and becomes a humidified air having an appropriate temperature, and is guided to the space Sdh around the occupant through the humidification-side opening 123 and the humidification-side duct 131.

The air conditioner 10 of the present embodiment described above has a configuration in which the direction of air flow in the adsorber 20 is reversed between the adsorption mode and the desorption mode by switching the ventilation path by the path switching mechanism 30. According to this, one of the pair of ventilation surfaces 201 and 202 of the adsorber 20 that serves as an air inflow surface in the adsorption mode serves as an air outflow surface in the desorption mode, and the other ventilation surface 202 that serves as an air outflow surface in the adsorption mode becomes an air inflow surface in the desorption mode. In such a configuration, the water that is unevenly distributed on the one ventilation surface 201 side of the adsorber 20 in the adsorption mode is received by the air flowing out from the one ventilation surface 201 in the desorption mode. The moisture becomes difficult to be adsorbed by the adsorbent 22 again. As a result, the humidifying function of the air conditioner 10 can be appropriately exerted.

Further, in the air conditioner 10 of the present embodiment, since the direction of air flow in the adsorber 20 is reversed by the path switching mechanism 30, it is not necessary to employ a blower capable of reversing the air suction direction and the air blowout direction. Therefore, the flexibility in selecting the blower 14 can be ensured.

Therefore, according to the air conditioner 10 of the present embodiment, it is possible to appropriately exhibit the humidity adjustment function of the air conditioner 10 while securing the freedom of selecting the blower 14.

The path switching mechanism 30 of the present embodiment switches the ventilation path, such that air flows in order of the cooler 16, the adsorber 20, and the heater 18 in the adsorption mode, and that air flows in order of the heater 18, the adsorber 20, and the cooler 16 in the desorption mode.

According to this, it is possible to suppress the temperature of the dehumidifying air generated in the adsorption mode from being excessively low, or to suppress the temperature of the humidifying air generated in the desorption mode from being excessively high. That is, it is possible to suppress the temperature of the room or the like from being changed more than necessary due to the humidity adjustment by the air conditioner 10.

### (Modification of First Embodiment)

Hereinafter, a modification of the air conditioner 10 described in the first embodiment will be described. Modifications of the first embodiment described below are applicable not only to the air conditioner 10 described in the first embodiment, but also to the first and subsequent embodiments.

In the first embodiment, the dehumidified air is exhausted to the outdoor space Sh, but is not limited to this. The air conditioner 10 supplies dehumidified air not to the outdoor space Sh but to, for example, an inner space Sh1 of a window glass of a house or a windshield of a vehicle as shown in FIG. 7.

The use of the humidifying air and the dehumidifying air is not limited to the humidity adjustment in a room such as a house or a vehicle, and can be effectively used in various situations. For example, humidified air can be used for animal and plant growth, food storage, and the like. In addition, the dehumidified air can be used for protection of electronic devices, protection of artworks, and the like.

In the first embodiment, the air conditioner 10 is used as a humidifier, but is not limited to this. The air conditioner 10 may be configured as, for example, a dehumidifier that exhausts humidified air to the outside and supplies dehumidified air to the room. The air conditioner 10 may be configured as a device that uses both humidified air and dehumidified air for indoor humidity.

In the first embodiment, the path switching mechanism 30 switches the ventilation path, so that air flows in the order of the cooler 16, the adsorber 20, and the heater 18 in the adsorption mode, but is not limited thereto. For example, in the adsorption mode, the path switching mechanism 30 may be configured to switch the ventilation path so that air flows in the order of the cooler 16 and the adsorber 20 but does not flow to the heater 18.

In the first embodiment, the path switching mechanism 30 switches the ventilation path, so that air flows in the order of the heater 18, the adsorber 20, and the cooler 16 in the desorption mode, but is not limited thereto. For example, in the desorption mode, the path switching mechanism 30 may be configured to switch the ventilation path so that air flows in the order of the heater 18 and the adsorber 20 but does not flow to the cooler 16.

### Second Embodiment

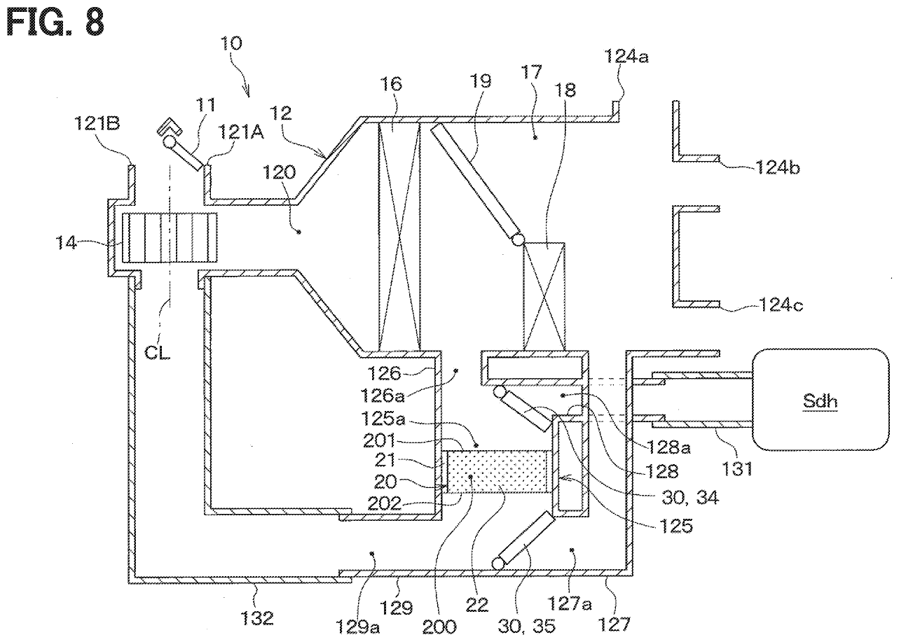

A second embodiment will be described with reference to FIGS. 8 to 10. In the present embodiment, the humidity control device of the present disclosure is applied to an air conditioner 10 that adjusts the temperature and humidity in a vehicle cabin. In the present embodiment, parts different from the first embodiment will be mainly described, and description of the same parts as the first embodiment will be omitted.

As shown in FIG. 8, the casing 12 of the present embodiment has an outside air inlet 121A for introducing outside air into the air passage 120 and an inside air inlet 121B for introducing inside air to the air passage 120 at the most upstream side of the air flow. The inside/outside air switching door 11 is provided alongside the outside air inlet 121A and the inside air inlet 121B. The outside air inlet 121A and the inside air inlet 121B are opened and closed by the inside/outside air switching door 11.

In the casing 12, a cooler 16 is disposed downstream of the blower 14 in the air flow, and a heater 18 is disposed downstream of the cooler 16 in the air flow. The casing 12 has a bypass passage 17 for bypassing the heater 18 and flowing air. The casing 12 includes an air mixing door 19 that adjusts the ratio of the amount of air passing through the heater 18 and the amount of air passing through the bypass passage 17.

Further, the casing 12 has plural blowout openings 124a to 124c for blowing the conditioned air adjusted to a desired temperature into the vehicle interior at the most downstream side of the air flow. Specifically, the casing 12 has a defroster opening 124a for blowing out conditioned air toward the windshield, a face opening 124b for blowing out conditioned air toward the upper body of the occupant, and a foot opening 124c for blowing out conditioned air toward the lower body of the occupant. The casing 12 has a mode switching door (not shown) for opening and closing each of the blowout openings 124a to 124c.

The casing 12 of the present embodiment has an adsorber housing 125, a cool air introduction unit 126, a warm air introduction unit 127, a humidified air outlet unit 128, and a dehumidified air outlet unit 129.

The adsorber housing 125 has an internal space 125a, and the adsorber 20 is disposed in the internal space 125a. That is, the adsorber 20 is housed in the adsorber housing 125.

The cool air introduction unit 126 forms a cool air introduction passage 126a for introducing the cool air generated by the cooler 16 to the adsorber 20. The cool air introduction passage 126a communicates with a space formed between the cooler 16 and the heater 18. The cool air introduction passage 126a of the present embodiment is provided to communicate with the space adjacent to the one ventilation surface 201 of the adsorber 20 in the internal space 125a of the adsorber housing 125 so that the cool air is introduced toward the one ventilation surface 201 of the adsorber 20.

The warm air introduction unit 127 forms a warm air introduction passage 127a for introducing the warm air generated by the heater 18 into the adsorber 20. The warm air introduction passage 127a communicates with a space on the downstream side of the heater 18 in the air flow. The warm air introduction passage 127a of the present embodiment is communicated with a space adjacent to the other ventilation surface 202 of the adsorber 20 in the internal space 125a of the adsorber housing 125 so that warm air is introduced toward the other ventilation surface 202 of the adsorber 20.

The humidified air outlet unit 128 has a humidified air outlet passage 128a for guiding the humidified air humidified by the adsorber 20 to the humidification-side duct 131. The humidified air outlet passage 128a communicates with the space adjacent to the one ventilation surface 201 of the adsorber 20 in the internal space 125a of the adsorber housing 125.

The dehumidified air outlet unit 129 has a dehumidified air outlet passage 129a formed therein for guiding dehumidified air dehumidified by the adsorber 20 to the dehumidification-side duct 132. The dehumidified air outlet passage 129a communicates with the space adjacent to the other ventilation surface 202 of the adsorber 20 in the internal space 125a of the adsorber housing 125.

Here, the downstream end of the dehumidification-side duct 132 in the air flow is connected to the air suction side of the blower 14 in the casing 12 so that the dehumidified air circulates in the casing 12.

The path switching mechanism 30 of the present embodiment will be described. The path switching mechanism 30 of the present embodiment has a first path switching door 34 and a second path switching door 35 disposed in the internal space 125a of the adsorber housing 125.

The first path switching door 34 is disposed in a space adjacent to the one ventilation surface 201 of the adsorber 20 in the internal space 125a of the adsorber housing 125. The first path switching door 34 is a door that selectively opens and closes the cool air introduction passage 126a and the humidified air outlet passage 128a. The first path switching door 34 is set at a position where the cool air introduction passage 126a is opened and the humidified air outlet passage 128a is closed in the adsorption mode, and the cool air introduction passage 126a is closed and the humidified air outlet passage 128a is opened in the desorption mode.

The second path switching door 35 is arranged in a space adjacent to the other ventilation surface 202 of the adsorber 20 in the internal space 125a of the adsorber housing 125. The second path switching door 35 is a door that selectively opens and closes the warm air introduction passage 127a and the dehumidified air outlet passage 129a. The second path switching door 35 is set at a position that closes the warm air introduction passage 127a and opens the dehumidified air outlet passage 129a in the adsorption mode, and opens the warm air introduction passage 127a and closes the dehumidified air outlet passage 129a in the desorption mode.

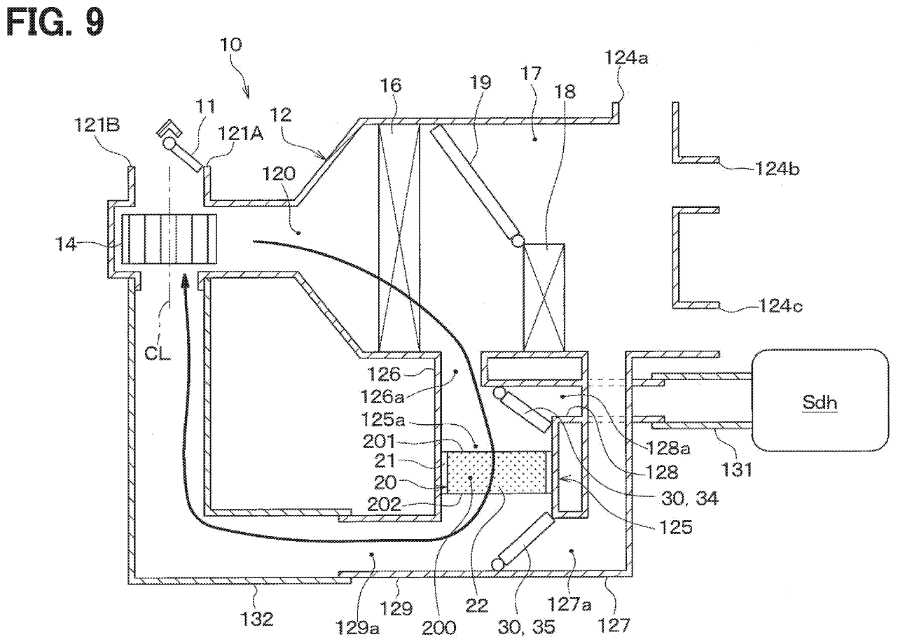

In the air conditioner 10 of the present embodiment, in the adsorption mode, as shown in FIG. 9, the path switching mechanism 30 switches the ventilation path to allow the cool air generated by the cooler 16 to flow into the adsorber 20 from the one ventilation surface 201 and to flow out from the other ventilation surface 202. Specifically, in the adsorption mode, the first path switching door 34 is set to a position where the cool air introduction passage 126a is opened and the humidified air outlet passage 128a is closed, and the second path switching door 35 is set at a position to close the warm air introduction passage 127a and open the dehumidified air outlet passage 129a.

Thus, in the adsorption mode, the low-temperature and high-humidity air cooled by the cooler 16 is introduced into the cool air introduction passage 126a. The low-temperature and high-humidity air introduced into the cool air introduction passage 126a flows into the adsorber 20 from the one ventilation surface 201. The low-temperature and high-humidity air that has flowed into the adsorber 20 is dehumidified by adsorbing moisture by the adsorbent 22 when passing through the ventilation path 200 inside the adsorber 20, and then flows out of the other ventilation surface 202 of the adsorber 20. The air dehumidified by the adsorber 20 is supplied to the air suction side of the blower 14 via the dehumidified air outlet passage 129a and the dehumidification side duct 132.

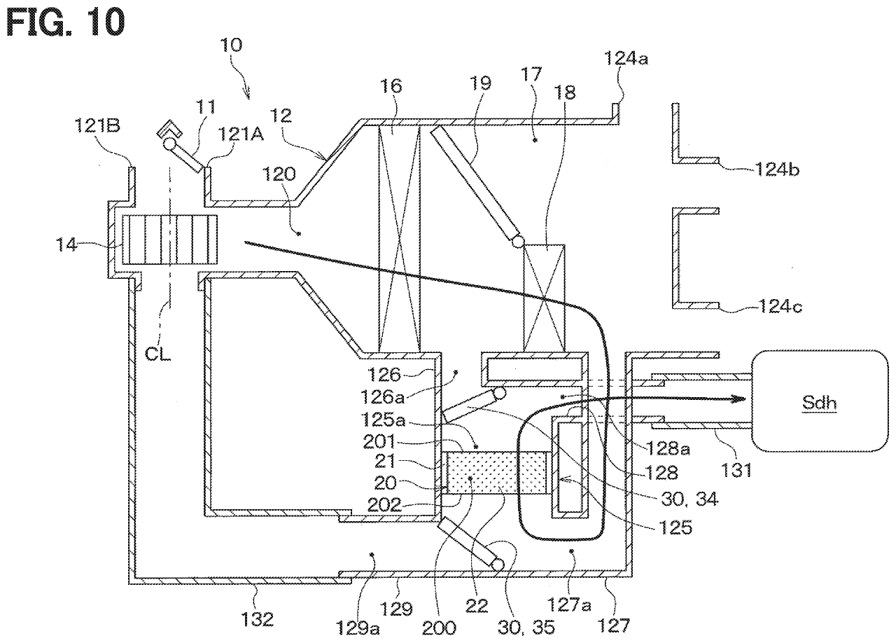

Further, in the air conditioner 10 of the present embodiment, in the desorption mode, as shown in FIG. 10, the airflow path is switched so that the warm air generated by the heater 18 is transferred from the other ventilation surface 202 to the adsorber 20 by the path switching mechanism 30, and the air flows out of the one ventilation surface 201. Specifically, in the desorption mode, the first path switching door 34 is set to a position where the cool air introduction passage 126a is closed and the humidified air outlet passage 128a is opened, and the second path switching door 35 is set to a position where the warm air introduction passage 127a is opened and the dehumidified air outlet passage 129a is closed.

Thus, in the desorption mode, the high-temperature and low-humidity air heated by the heater 18 is introduced into the warm air introduction passage 127a. The high-temperature and low-humidity air introduced into the warm air introduction passage 127a flows into the adsorber 20 from the other ventilation surface 202. The high-temperature and low-humidity air that has flowed into the adsorber 20 is humidified by moisture released from the adsorbent 22 when passing through the ventilation path 200 inside the adsorber 20, and then flows out from the one ventilation surface 201 of the adsorber 20. At this time, since the air flowing out of the one ventilation surface 201 receives the water biased to the one ventilation surface 201 of the adsorber 20, the air having received the moisture is not adsorbed by the adsorbent 22 again and becomes humidified air with high relative humidity. The air humidified by the adsorber 20 is guided to the space Sdh around the occupant via the humidified air outlet passage 128a and the humidification-side duct 131.

The air conditioner 10 of the present embodiment described above has a configuration in which the direction of air flow in the adsorber 20 is reversed between the adsorption mode and the desorption mode by switching the ventilation path by the path switching mechanism 30. Therefore, according to the air conditioner 10 of the present embodiment, similarly to the first embodiment and the like, it is possible to appropriately exhibit the humidity adjustment function of the air conditioner 10 while securing the freedom of selecting the blower 14.

The air conditioner 10 of the present embodiment is configured to adjust the temperature and the humidity in the vehicle cabin by using the common blower 14, cooler 16, and heater 18. According to this, there is an advantage that a device dedicated to temperature adjustment and a device dedicated to humidity adjustment can be reduced.

### (Modification of Second Embodiment)

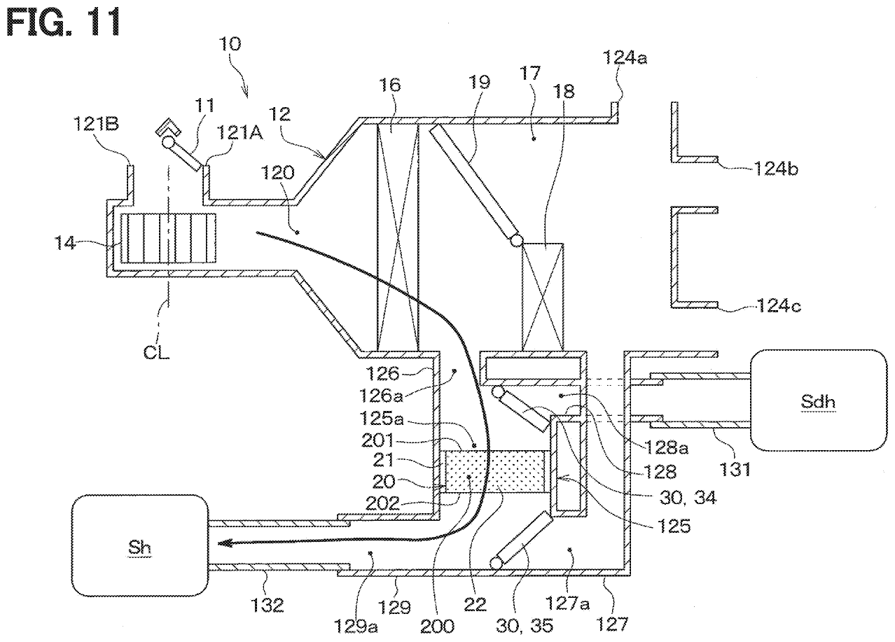

In the second embodiment, the dehumidified air is circulated inside the casing 12, but is not limited to this. The air conditioner 10 may be configured to exhaust dehumidified air to the outdoor space Sh, as shown in FIG. 11.

### Third Embodiment

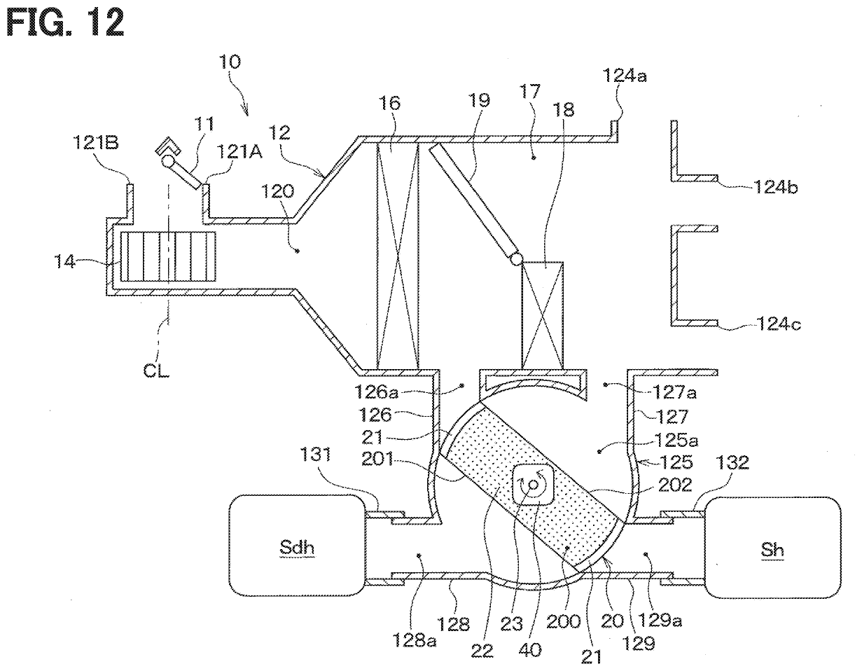

A third embodiment will be described with reference to FIGS. 12 to 16. In the present embodiment, instead of the path switching mechanism 30, an adsorber displacement mechanism 40 that rotationally displaces the adsorber 20 reverses the direction of air flow in the adsorber 20 between the adsorption mode and the desorption mode. This is different from the second embodiment. In the present embodiment, parts different from the second embodiment will be mainly described, and description of the same parts as the second embodiment will be omitted.

As shown in FIG. 12, the adsorber 20 of the present embodiment includes a rotating shaft 23 extending along the plane direction of the pair of ventilation surfaces 201 and 202. When the rotating shaft 23 is rotated, the positions of the pair of ventilation surfaces 201 and 202 of the adsorber 20 change. The rotating shaft 23 is rotatably supported by the adsorber housing 125.

The adsorber housing 125 of the present embodiment has the adsorber 20 rotatably housed in the internal space 125a. The size of the internal space 125a of the adsorber housing 125 is set such that a gap between the inner wall surface of the adsorber housing 120 and the outer wall surface of the side wall 21 of the adsorber 20 is a minute gap. That is, the inner diameter of the adsorber housing 125 is substantially equal to the outer diameter of the side wall 21 of the adsorber 20.

The cool air introduction unit 126, the warm air introduction unit 127, the humidified air outlet unit 128, and the dehumidified air outlet unit 129 are connected to the adsorber housing 125. The cool air introduction unit 126 and the dehumidified air outlet unit 129 are connected to portions of the adsorber housing 125 at positions facing each other with the rotating shaft 23 of the adsorber 20 interposed therebetween. Further, the warm air introduction unit 127 and the humidified air outlet unit 128 are connected to portions of the adsorber housing 125 at positions facing each other with the rotating shaft 23 of the adsorber 20 interposed therebetween. Note that a downstream end of the dehumidification-side duct 132 of the present embodiment in the air flow is communicated with the outdoor space Sh so that the dehumidified air is exhausted to the outdoor space Sh.

The air conditioner 10 of the present embodiment has the adsorber displacement mechanism 40 that displaces the adsorber 20 so that the positions of the pair of ventilation surfaces 201 and 202 change. The adsorber displacement mechanism 40 includes an electric motor (for example, a stepping motor) that outputs a driving force for driving the rotation shaft 23 of the adsorber 20 to rotate.

The adsorber displacement mechanism 40 displaces the adsorber 20 such that the positions of the pair of ventilation surfaces 201 and 202 in the air passage 120 are reversed between the adsorption mode and the desorption mode. That is, the adsorber displacement mechanism 40 displaces the adsorber 20 so that the one ventilation surface 201 is located on the upstream side of the other ventilation surface 202 in the air flow in the air passage 120 in the adsorption mode. Further, the adsorber displacement mechanism 40 displaces the adsorber 20 so that the other ventilation surface 202 is located on the upstream side of the one ventilation surface 201 in the air flow in the air passage 120 in the desorption mode.

Specifically, the adsorber displacement mechanism 40 of the present embodiment rotationally displaces the adsorber 20 to a position where the cool air introduction passage 126a and the dehumidified air outlet passage 129a communicate with each other via the ventilation path 200 in the adsorption mode. At this time, the warm air introduction passage 127a and the humidified air outlet passage 128a are closed by the side wall 21 of the adsorber 20. That is, in the adsorption mode, the adsorber displacement mechanism 40 rotationally displaces the adsorber 20 to a position where communication between the warm air introduction passage 127a and the humidified air outlet passage 128a is shut off by the side wall 21 of the adsorber 20.

In the desorption mode, the adsorber displacement mechanism 40 of the present embodiment rotationally displaces the adsorber 20 to a position where the warm air introduction passage 127a and the humidified air outlet passage 128a communicate with each other via the ventilation path 200. At this time, the cool air introduction passage 126a and the dehumidified air outlet passage 129a are closed by the side wall 21 of the adsorber 20. That is, in the desorption mode, the adsorber displacement mechanism 40 rotationally displaces the adsorber 20 to a position where communication between the cool air introduction passage 126a and the dehumidified air outlet passage 129a is shut off by the side wall 21 of the adsorber 20.

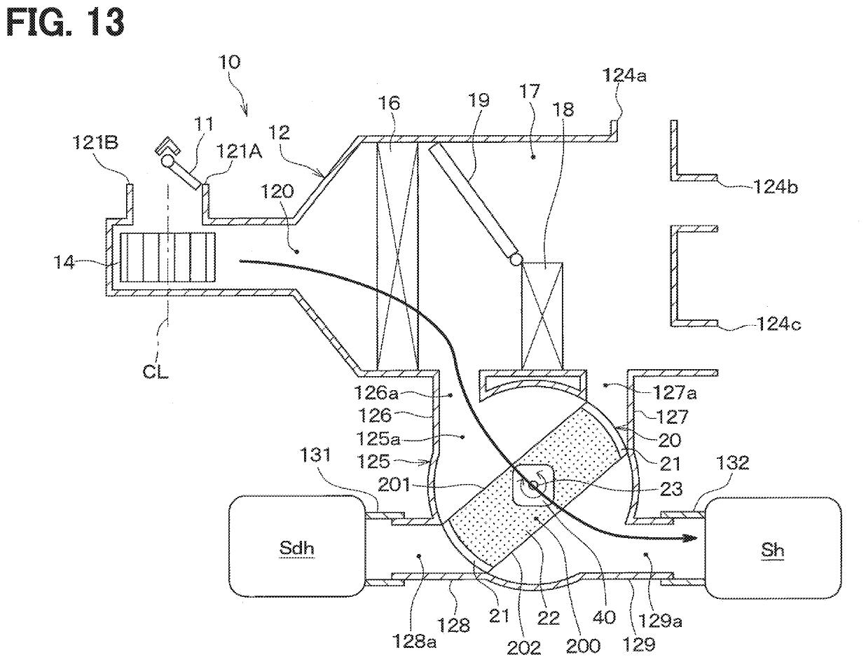

In the adsorption mode, as shown in FIG. 13, the air conditioner 10 of the present embodiment uses the adsorber displacement mechanism 40 to displace the adsorber 20, so that the cool air introduction passage 126a and the dehumidified air outlet passage 129a communicate with each other through the ventilation path 200. At this time, the adsorber displacement mechanism 40 displaces the adsorber 20 such that one ventilation surface 201 of the adsorber 20 is located on the upstream side of the other ventilation surface 202 in the air flow.

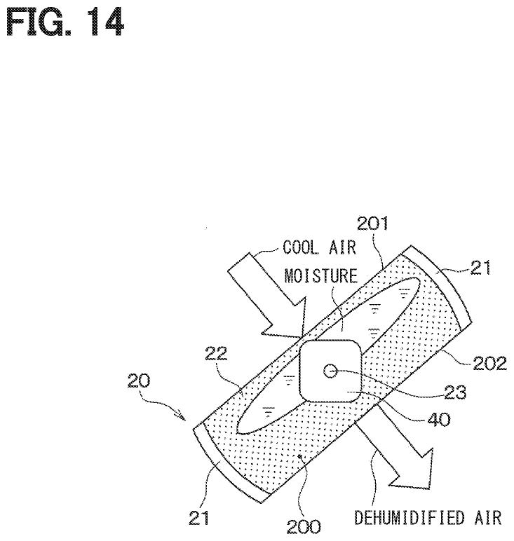

Thus, in the adsorption mode, the low-temperature and high-humidity air cooled by the cooler 16 is introduced into the cool air introduction passage 126a. The low-temperature and high-humidity air introduced into the cool air introduction passage 126a flows into the adsorber 20 from the one ventilation surface 201. The low-temperature and high-humidity air that has flowed into the adsorber 20 is dehumidified by adsorbing moisture by the adsorbent 22 when passing through the ventilation path 200 inside the adsorber 20. At this time, as shown in FIG. 14, the moisture adsorbed by the adsorbent 22 in the adsorption mode tends to be biased toward the one ventilation surface 201 as an air inflow surface, of the pair of ventilation surfaces 201 and 202 of the adsorber 20.

Returning to FIG. 13, the air dehumidified by the adsorption of the moisture by the adsorbent 22 flows out of the other ventilation surface 202 of the adsorber 20, and the air is exhausted to the outdoor space Sh through the dehumidified air outlet passage 129a and the dehumidification-side duct 132.

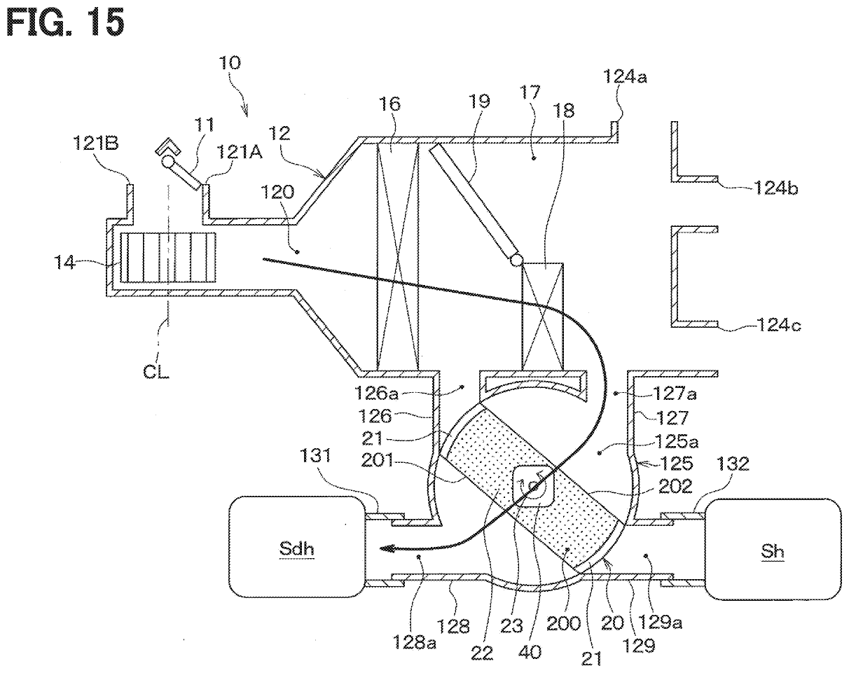

In the desorption mode, as shown in FIG. 15, in the air conditioner 10 of the present embodiment, the adsorber 20 is displaced by the displacement mechanism 40 such that the warm air introduction passage 127a and the humidified air outlet passage 128a communicate with each other through the ventilation path 200. At this time, the adsorber displacement mechanism 40 displaces the adsorber 20 such that the other ventilation surface 202 of the adsorber 20 is located on the upstream side of the one ventilation surface 201 in the air flow.

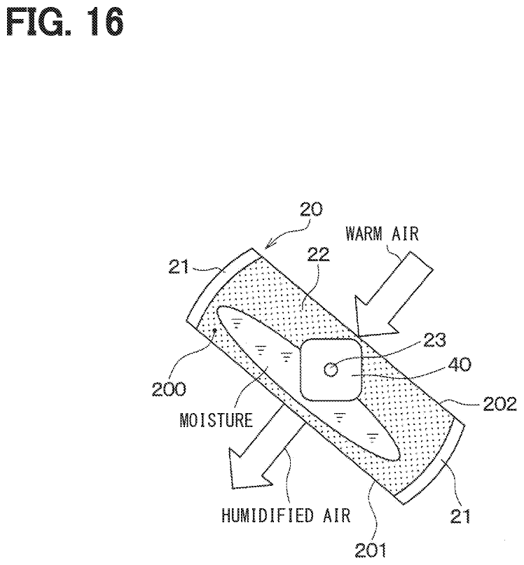

Thus, in the desorption mode, the high-temperature and low-humidity air heated by the heater 18 is introduced into the warm air introduction passage 127a. The high-temperature and low-humidity air introduced into the warm air introduction passage 127a flows into the adsorber 20 from the other ventilation surface 202. The high-temperature and low-humidity air that has flowed into the adsorber 20 is humidified by moisture released from the adsorbent 22 when passing through the ventilation path 200 inside the adsorber 20, and then the air flows out from the one ventilation surface 201 of the adsorber 20. At this time, the air flowing out of the one ventilation surface 201 receives the water biased on the one ventilation surface 201 of the adsorber 20. Therefore, as shown in FIG. 16, the air having received the moisture is restricted from again adsorbed by the adsorbent 22, and becomes humidified air having a high relative humidity. The air humidified by the adsorber 20 is guided to the space Sdh around the occupant via the humidified air outlet passage 128a and the humidification-side duct 131.

The air conditioner 10 of the present embodiment has a configuration in which the adsorber 20 is displaced by the adsorber displacement mechanism 40 to reverse the direction of air flow in the adsorber 20 between the adsorption mode and the desorption mode. Therefore, according to the air conditioner 10 of the present embodiment, similarly to the first embodiment and the like, it is possible to appropriately exhibit the humidity adjustment function of the air conditioner 10 while securing the freedom of selecting the blower 14.

In the present embodiment, the side wall 21 of the adsorber 20 corresponds to a communication shut-off member or communication blocking unit that shuts off the communication between the warm air introduction passage 127a and the humidified air outlet passage 128a in the adsorption mode, and that blocks communication between the cool air introduction passage 126a and the dehumidified air outlet passage 129a in the desorption mode. According to this, it is possible to suppress an increase in the number of components in the air conditioner 10 as compared with a case where the communication blocking unit is formed of a separate member (for example, a door member).

### (Modification of Third Embodiment)

In the third embodiment, the side wall 21 of the adsorber 20 functions as the communication blocking unit, but is not limited to this. The communication blocking unit includes, for example, an opening/closing door that selectively opens and closes the warm air introduction passage 127a and the cool air introduction passage 126a, and an opening/closing door that selectively opens and closes the humidified air outlet passage 128a and the dehumidified air outlet passage 129a.

In the third embodiment, the air conditioner 10 can perform the temperature adjustment and the humidity adjustment in the vehicle cabin, but the air conditioner 10 is not limited to this. The air conditioner 10 may be configured to perform only humidity adjustment, for example, as in the first embodiment. The same also applies to the following embodiments.

### Fourth Embodiment

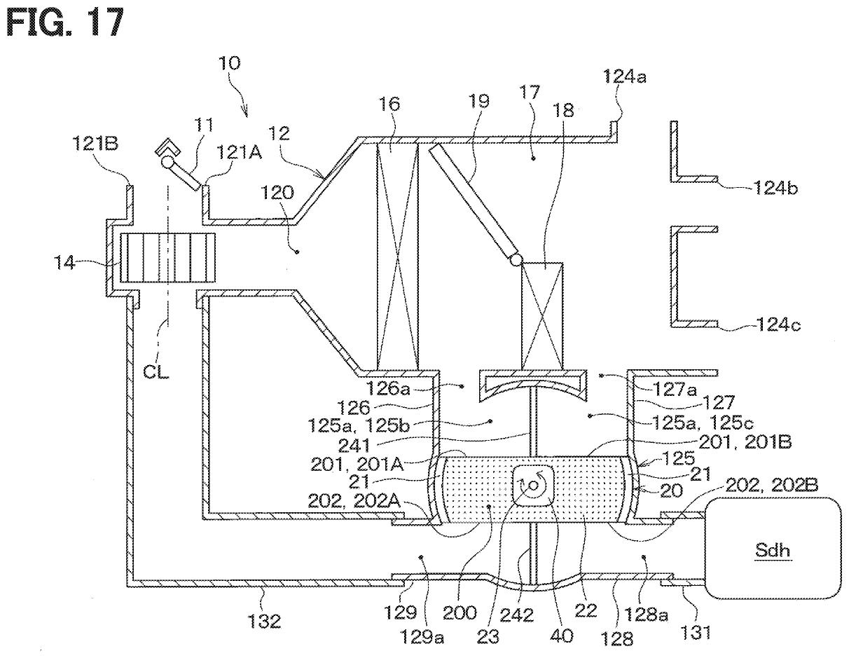

A fourth embodiment will be described with reference to FIGS. 17 to 19. The present embodiment is different from the third embodiment in that the internal space 125a of the adsorber housing 125 is divided into a cool air passage 125b through which cool air flows and a warm air passage 125c through which warm air flows. In the present embodiment, parts different from the third embodiment will be mainly described, and description of the same parts as the third embodiment will be omitted.

As shown in FIG. 17, the adsorber housing 125 has a pair of partition walls 241 and 242 that partition the internal space 125a into the cool air passage 125b and the warm air passage 125c. The adsorber 20 is arranged so as to straddle both the cool air passage 125b and the warm air passage 125c.

The pair of partition walls 241 and 242 of the present embodiment are fixed to the adsorber 20 and are rotationally displaced together with the adsorber 20. Of the pair of partition walls 241 and 242, one partition wall 241 is provided on the one ventilation surface 201 of the adsorber 20, and the other partition wall 242 is provided on the other ventilation surface 202 of the adsorber 20. The one ventilation surface 201 is divided into a first ventilation portion 201A and a second ventilation portion 201B by the one partition wall 241. The other ventilation surface 202 is divided into a third ventilation portion 202A and a fourth ventilation portion 202B by the other partition wall 242.

The adsorber housing 125 is connected with the cool air introduction unit 126, the warm air introduction unit 127, the humidified air outlet unit 128, and the dehumidified air outlet unit 129 so that the cool air flowing through the cool air passage 125b and the warm air flowing through the warm air passage 125c become parallel flows. That is, the cool air introduction unit 126 and the warm air introduction unit 127 are connected to the adsorber housing 125 so as to be adjacent to each other, and the humidified air outlet unit 128 and the dehumidified air outlet unit 129 are connected to the adsorber housing 125 so as to be adjacent to each other.

Specifically, in the adsorber housing 125, the cool air introduction unit 126 and the humidified air outlet unit 128 are connected to portions of the adsorber housing 125 at positions facing each other with the rotating shaft 23 of the adsorber 20 interposed therebetween. In the adsorber housing 125, the warm air introduction unit 127 and the dehumidified air outlet unit 129 are connected to portions of the adsorber housing 125 at positions facing each other with the rotating shaft 23 of the adsorber 20 interposed therebetween. The downstream end of the dehumidification-side duct 132 of the present embodiment in the air flow is connected to the air suction side of the blower 14 in the casing 12 so that the dehumidified air circulates in the casing 12.

The adsorber displacement mechanism 40 of the present embodiment displaces the adsorber 20 such that the positions of the pair of ventilation surfaces 201 and 202 are reversed in the internal space 125a of the adsorber housing 125. That is, the adsorber displacement mechanism 40 is configured to displace the adsorber 20 to the position where the cool air and the warm air flowing in from the one ventilation surface 201 flow out from the other ventilation surface 202 and to the position where the cool air and the warm air flowing in from the other ventilation surface 202 flow out from the one ventilation surface 201.

Specifically, the adsorber displacement mechanism 40 displaces the adsorber 20 to a position where the cool air flowing in from the first ventilation portion 201A of the one ventilation surface 201 flows out from the third ventilation portion 202A of the other ventilation surface 202. At this time, the warm air flowing in from the second ventilation portion 201 B of the one ventilation surface 201 flows out from the fourth ventilation portion 202B of the other ventilation surface 202.

Further, the adsorber displacement mechanism 40 displaces the adsorber 20 to a position where the warm air flowing in from the third ventilation portion 202A of the other ventilation surface 201 flows out from the first ventilation portion 201A of the one ventilation surface 201. At this time, the cool air flowing in from the fourth ventilation portion 202B of the other ventilation surface 202 flows out of the second ventilation portion 201B of the one ventilation surface 202.

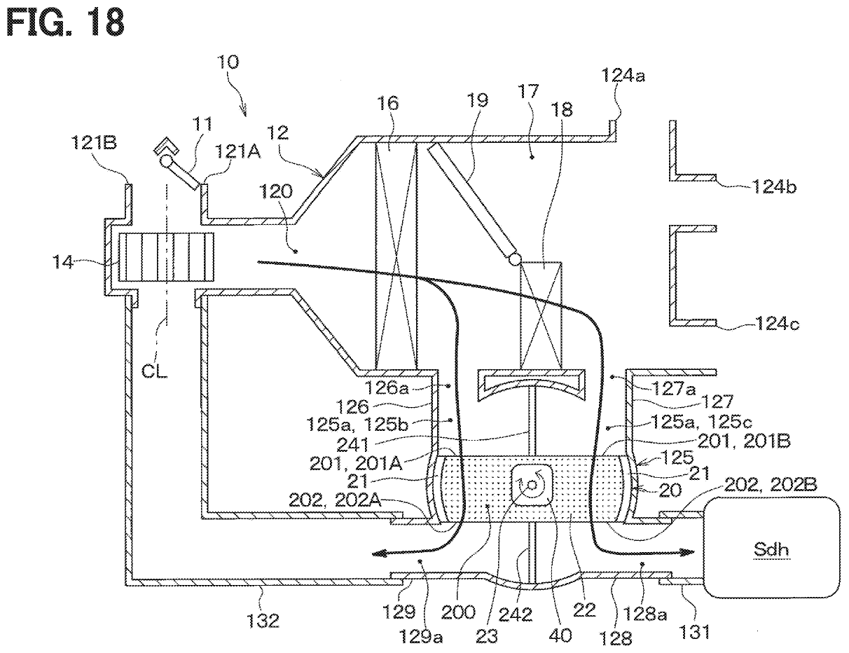

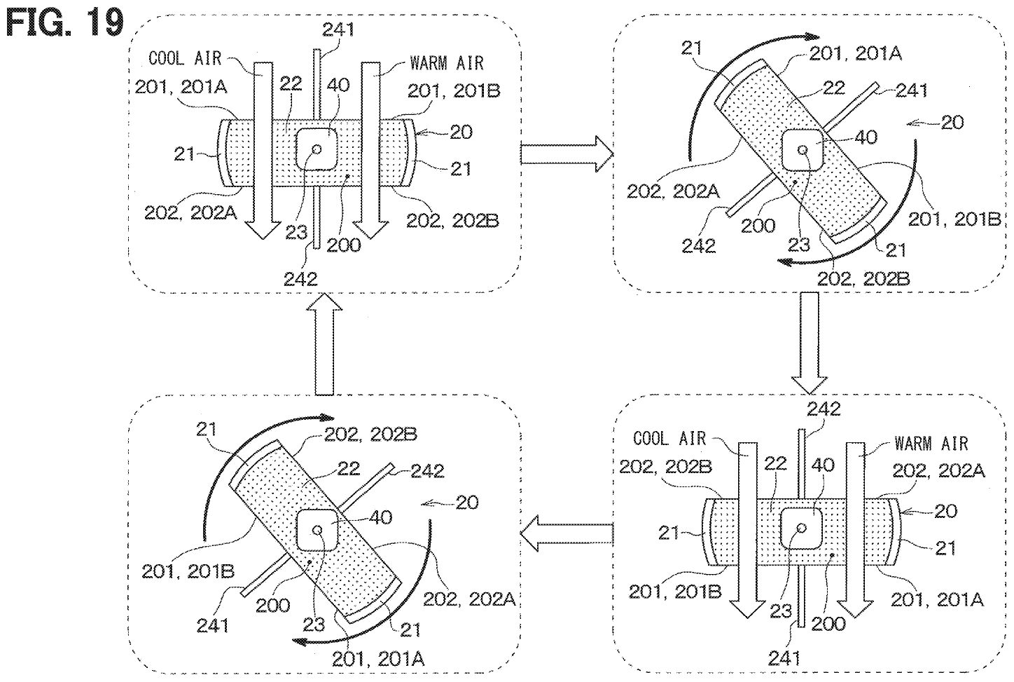

The operation of the air conditioner 10 of the present embodiment will be described with reference to FIGS. 18 and FIG. 19. FIG. 18 illustrates an operation state of the air conditioner 10 when the adsorber 20 is set at a position where the cool air and the warm air flowing in from the one ventilation surface 201 flow out from the other ventilation surface 202.

In the operating state shown in FIG. 18, the low-temperature and high-humidity air cooled by the cooler 16 is introduced into the cool air passage 125b through the cool air introduction passage 126a, and the high-temperature and low-humidity air heated by the heater 18 is introduced into the warm air passage 125c through the air introduction passage 127a.

The low-temperature and high-humidity air introduced into the cool air passage 125b flows from the first ventilation portion 201A of the one ventilation surface 201 to a portion of the adsorber 20 adjacent to the cool air passage 125b. The low-temperature and high-humidity air that has flowed into the adsorber 20 is dehumidified by adsorbing moisture by the adsorbent 22 when passing through the ventilation path 200 inside the adsorber 20. Then, the air dehumidified by the adsorption of the moisture by the adsorbent 22 flows out of the third ventilation portion 202A of the other ventilation surface 202 of the adsorber 20, and then the air is supplied to the air suction side of the blower 14 through the dehumidified air outlet passage 129a and the dehumidification side duct 132.

On the other hand, the high-temperature and low-humidity air introduced into the warm air passage 125c flows from the second ventilation portion 201B of the one ventilation surface 201 to a portion of the adsorber 20 adjacent to the warm air passage 125c. The high-temperature and low-humidity air that has flowed into the adsorber 20 is humidified by moisture released from the adsorbent 22 when passing through the ventilation path 200 inside the adsorber 20, and then flows out of the four ventilation portion 202B of the other ventilation surface 202 of the adsorber 20. The air humidified by the adsorber 20 is guided to the space Sdh around the occupant via the humidified air outlet passage 128a and the humidification-side duct 131.

As described above, in the air conditioner 10 of the present embodiment, since the adsorber 20 is disposed so as to straddle both the cool air passage 125b and the warm air passage 125c, it is possible to simultaneously generate dehumidified air and humidified air.

In the operating state shown in FIG. 18, moisture tends to be unevenly distributed to a part of the adsorber 20 adjacent to the first ventilation portion 201A of the one ventilation surface 201 into which the cool air is introduced. Therefore, in the air conditioner 10 of the present embodiment, when the water is unevenly distributed on the part of the adsorber 20, the adsorber 20 is rotated by approximately 180 degrees by the adsorber displacement mechanism 40 as shown in FIG. 19. It is determined that the water is unevenly distributed on the part of the adsorber 20 when the water content in the part of the adsorber 20 exceeds a predetermined amount, or when a predetermined time elapses after the adsorber 20 is rotationally displaced.

In a state where the adsorber 20 is displaced by about degrees from the operation state of FIG. 18, the low-temperature and high-humidity air introduced into the cool air passage 125b flows from the fourth ventilation portion 202B of the other ventilation surface 202 into the cool air passage 125b of the adsorber 20. The low-temperature and high-humidity air that has flowed into the adsorber 20 is dehumidified by adsorbing moisture by the adsorbent 22 when passing through the ventilation path 200 inside the adsorber 20. Then, the air dehumidified by the adsorption of the moisture by the adsorbent 22 flows out of the second ventilation portion 201 B of the one ventilation surface 201 of the adsorber 20, and then the air is exhausted to the outdoor space Sh through the dehumidified air outlet passage 129a and the dehumidification-side duct 132.

On the other hand, the high-temperature and low-humidity air introduced into the warm air passage 125c flows from the third ventilation portion 202A of the other ventilation surface 202 into a portion of the adsorber 20 adjacent to the warm air passage 125c. The high-temperature and low-humidity air that has flowed into the adsorber 20 is humidified by moisture released from the adsorbent 22 when passing through the ventilation path 200 inside the adsorber 20, and then flows out from the first ventilation portion 201A of the one ventilation surface 201 of the adsorber 20. At this time, the air flowing out of the first ventilation portion 201A receives the water biased to the first ventilation portion 201A. Therefore, the moisture received by the air is not again adsorbed to the adsorbent 22 so as to provide humidified air with relatively high humidity. The air humidified by the adsorber 20 is guided to the space Sdh around the occupant via the humidified air outlet passage 128a and the humidification-side duct 131.

The air conditioner 10 of the present embodiment can reverse the flow directions of the cool air and the warm air in the ventilation path 200 of the adsorber 20 by displacing the adsorber 20 by the adsorber displacement mechanism 40. Therefore, according to the air conditioner 10 of the present embodiment, similarly to the first embodiment and the like, it is possible to appropriately exhibit the humidity adjustment function of the air conditioner 10 while securing the freedom of selecting the blower 14.

In the present embodiment, the adsorber 20 is disposed so as to straddle both the cool air passage 125b and the warm air passage 125c. Therefore, the adsorbent 22 simultaneously exhibits the functions of adsorbing and desorbing the moisture, and it is possible to simultaneously generate dehumidified air and humidified air.

### (Modification of Fourth Embodiment)

In the fourth embodiment, dehumidified air is circulated inside the casing 12, but is not limited to this. The air conditioner 10 may be configured to, for example, exhaust dehumidified air to the outdoor space Sh.

### Fifth Embodiment

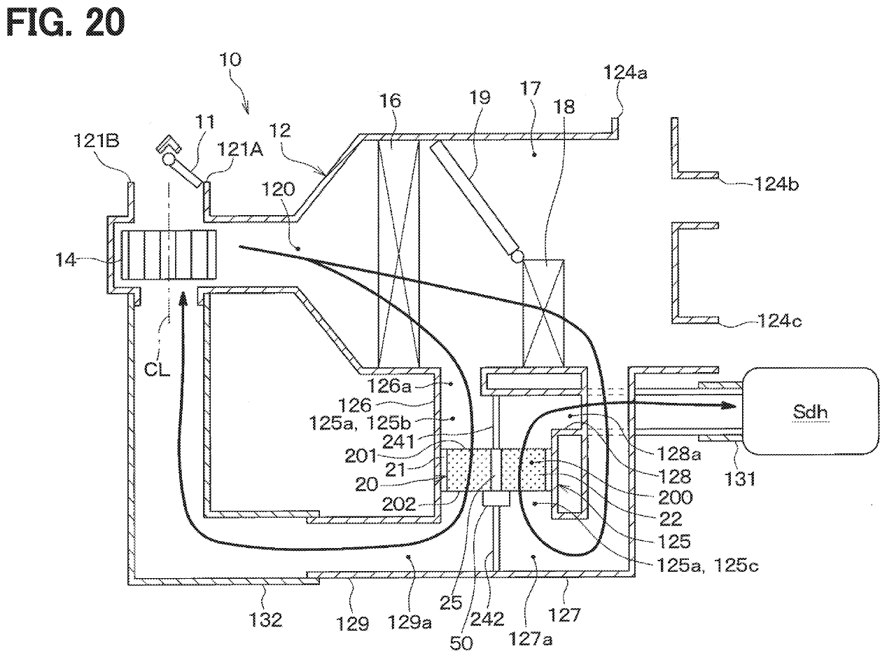

A fifth embodiment will be described with reference to FIGS. 20 to 22, and is different from the fourth embodiment as follows. In the present embodiment, the cool air and the warm air flowing inside the adsorber housing 125 are configured to be countercurrent, and the adsorbent 22 can be moved from one of the cool air passage 125b and the warm air passage 125c to the other. In the present embodiment, parts different from the fourth embodiment will be mainly described, and description of the same parts as the fourth embodiment will be omitted.

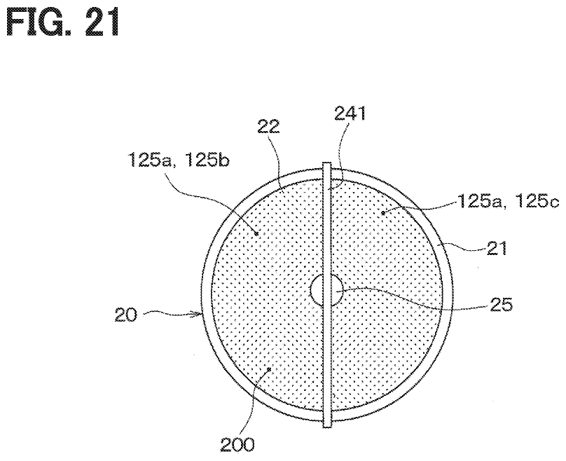

As shown in FIGS. 20 and 21, in the adsorber housing 125 of the present embodiment, the internal space 125a is partitioned into a cool air passage 125b and a warm air passage 125c by a pair of partition walls 241 and 242. The pair of partition walls 241 and 242 of the present embodiment are fixed to the adsorber housing 125. Therefore, the position of the pair of partition walls 241 and 242 does not change even when the adsorber 20 rotates.

The cool air introduction unit 126, the warm air introduction unit 127, the humidified air outlet unit 128 and the dehumidified air outlet unit 129 are connected to the adsorber housing 125 of the present embodiment so that the cool air flowing through the cool air passage 125b and the warm air flowing through the warm air passage 125c flow in opposite directions. That is, the cool air introduction unit 126 and the humidified air outlet unit 128 are connected to the adsorber housing 125 so as to be adjacent to each other, and the warm air introduction unit 127 and the dehumidified air outlet unit 129 are connected to the adsorber housing 125 so as to be adjacent to each other.

Specifically, the cool air introduction unit 126 and the humidified air outlet unit 128 are connected to a portion of the adsorber housing 125 located adjacent to the one ventilation surface 201 of the adsorber 20, and the warm air introduction unit 127 and the dehumidified air outlet unit 129 are connected to a portion of the adsorber housing 125 located adjacent to the other ventilation surface 202.

The adsorber 20 of the present embodiment is arranged so as to straddle both the cool air passage 125b and the warm air passage 125c. Specifically, the adsorber 20 is arranged across both of the cool air passage 125b and the warm air passages 125c so that a part of the one ventilation surface 201 becomes an inflow surface for the cool air and the rest of the one ventilation surface 201 becomes an outflow surface for the warm air. Further, the adsorber 20 is arranged across both of the cool air passage 125b and the warm air passages 125c so that a part of the other ventilation surface 202 serves as an air outflow surface for the cool air and the rest of the other ventilation surface 201 serves as an inflow surface for the warm air.

Further, the adsorber 20 of the present embodiment has a rotating shaft 25 extending along an opposing direction in which the pair of ventilation surfaces 201 and 202 face each other (ie, the direction of air flow). When the rotating shaft 25 is rotated, a part of the adsorbent 22 located on the side of the cool air passage 125b is displaced to the side of the warm air passage 125c, and a part of the adsorbent 22 located on the side of the warm air passage 125c is displaced toward the cool air passage 125b. The rotating shaft 25 is driven to rotate by a driving mechanism 50.

The driving mechanism 50 rotates the rotating shaft 25 provided in the adsorber 20 to move the adsorbent 22 located on the side of the cool air passage 125b to the side of the warm air passage 125c, or move the adsorbent 22 located on the side of the warm air passage 125c to the side of the cool air passage 125b. The driving mechanism 50 includes an electric motor (for example, a stepping motor) that outputs a driving force for driving the rotation shaft 25 of the adsorber 20 to rotate.

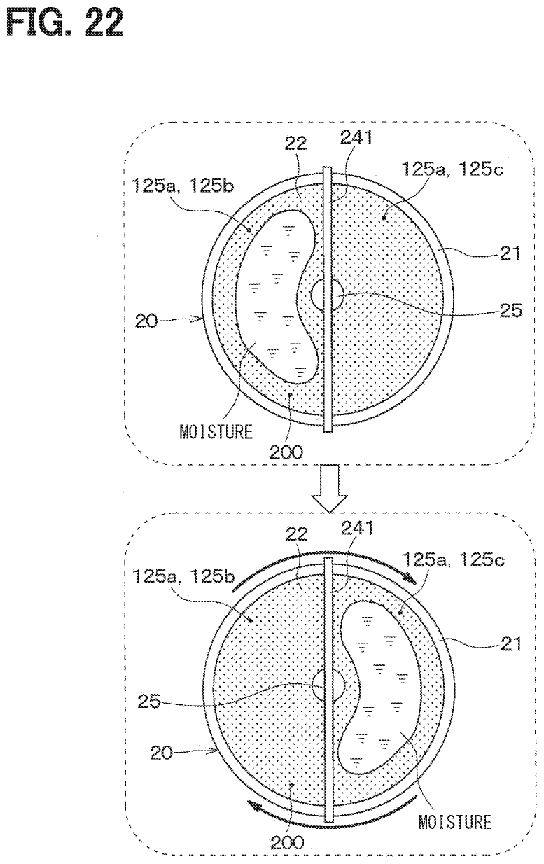

The operation of the air conditioner 10 of the present embodiment will be described with reference to FIG. 20 and FIG. 22. As shown in FIG. 20, in the air conditioner 10 of the present embodiment, when the blower 14 operates, the low-temperature and high-humidity air cooled by the cooler 16 is introduced into the cool air passage 125b, and the high-temperature and low-humidity air heated by the heater 18 is introduced into the warm air passage 125c.

The low-temperature and high-humidity air introduced into the cool air passage 125b flows from the one ventilation surface 201 into a portion of the adsorber 20 on the side of the cool air passage 125b. The low-temperature and high-humidity air that has flowed into the adsorber 20 is dehumidified by adsorbing moisture by the adsorbent 22 when passing through the ventilation path 200 inside the adsorber 20. The air that has been dehumidified by the adsorption of moisture by the adsorbent 22 flows out of the other ventilation surface 202 of the adsorber 20, and then, is supplied to the suction side of the blower 14 through the dehumidified air outlet passage 129a and the dehumidification-side duct 132.

On the other hand, the high-temperature and low-humidity air introduced into the warm air passage 125c flows into the adsorber 20 on the side of the warm air passage 125c from the other ventilation surface 202. The high-temperature and low-humidity air that has flowed into the adsorber 20 is humidified by moisture released from the adsorbent 22 when passing through the ventilation path 200 inside the adsorber 20, and then flows out from the one ventilation surface 201 of the adsorber 20. At this time, since the warm air flowing out of the one ventilation surface 201 receives the water biased to the one ventilation surface 201 of the adsorber 20, the air having received the moisture is restricted from being again adsorbed by the adsorbent 22. Thus, humidified air can be provided with high relative humidity. The air humidified by the adsorber 20 is guided to the space Sdh around the occupant via the humidified air outlet passage 128a and the humidification-side duct 131.

As described above, in the air conditioner 10 of the present embodiment, since the adsorber 20 is disposed so as to straddle both the cool air passage 125b and the warm air passage 125c, it is possible to simultaneously generate dehumidified air and humidified air.

In the operation state shown in the upper part of FIG. 22, moisture tends to be unevenly distributed to a portion of the one ventilation surface 201 of the adsorber 20 on the side of the cool air passage 125b. In the air conditioner 10 of the present embodiment, when a condition is satisfied that the moisture is unevenly distributed in the portion of the one ventilation surface 201 on the side of the cool air passage 125b, as shown in the lower part of FIG. 22, the adsorbent 22 is rotated by approximately 180 degrees by the driving mechanism 50. The condition that water is unevenly distributed in one part of the adsorber 20 is satisfied when the water content in one part of the adsorber 20 exceeds a predetermined amount, or a predetermined time elapses after the adsorber 20 is rotationally displaced.

When the adsorbent 22 is rotated by approximately 180 degrees, the adsorbent 22 that has adsorbed moisture on the side of the cool air passage 125b moves to the side of the warm air passage 125c, and the adsorbent 22 that has desorbed moisture on the side of the warm air passage 125c moves to the side of the cool air passage 125b. According to this, the water that is biased toward the inflow surface side for the cool air of the one ventilation surface 201 of the adsorber 20 can be moved to the outflow surface side for the warm air together with the adsorbent 22. Thus, humidified air can be generated efficiently.

In the present embodiment described above, the adsorber 20 is disposed so as to straddle both of the passages 125b and 125c so that the cool air flowing in from the one ventilation surface 201 flows out of the other ventilation surface 202, and that the warm air flowing in from the other ventilation surface 202 flows out of the one ventilation surface 201.

According to this, even if moisture is unevenly distributed on the one ventilation surface 201 side, the moisture is used for humidifying the warm air flowing out from the one ventilation surface 201. Therefore, according to the air conditioner 10 of the present embodiment, similarly to the first embodiment and the like, it is possible to appropriately exhibit the humidity adjustment function of the air conditioner 10 while securing the freedom of selecting the blower 14.

Further, in the present embodiment, since the adsorber 20 is disposed so as to straddle both the cool air passage 125b and the warm air passage 125c, the adsorbent 22 can simultaneously exhibit the water adsorbing action and the desorbing action. That is, according to the air conditioner 10 of the present embodiment, it is possible to simultaneously generate dehumidified air and humidified air.

Further, in the present embodiment, the adsorbent 22 that has absorbed moisture in the cool air passage 125b is moved to the warm air passage 125c, and the adsorbent 22 that has desorbed moisture in the warm air passage 125c is moved to the cool air passage 125b. For this reason, it is possible to continuously generate dehumidified air and humidified air.

In the present embodiment, unlike the fourth embodiment, even when the adsorber 20 is rotated, the pair of ventilation surfaces 201 and 202 are not displaced, so that cool air and warm air can be supplied to the adsorber 20 without interruption so as to continuously generate dehumidified air and humidified air.

### (Modification of Fifth Embodiment)

In the fifth embodiment, the dehumidified air is circulated inside the casing 12, but is not limited to this. The air conditioner 10 may be configured to exhaust dehumidified air to the outdoor space Sh.

In the fifth embodiment, the driving mechanism 50 rotates the adsorbent 22 by approximately 180 degrees when the condition that the moisture is unevenly distributed in the portion of the adsorbent 22 on the side of the cool air passage 125b is satisfied, but is not limited to this. The air conditioner 10 may have a configuration in which, for example, the driving mechanism 50 constantly rotates the adsorber 20 at a predetermined speed during the humidity adjustment operation.

In the fifth embodiment, the adsorbent 22 is moved by rotating the adsorber 20 by the driving mechanism 50, but is not limited to this. The driving mechanism 50 may be configured to move the adsorbent 22 by means other than the rotation of the adsorber 20.

### (Other Embodiments)

Although representative embodiments of the present disclosure have been described above, the present disclosure is not limited to the embodiments described above, and various modifications can be made, for example, as follows.

In each of the embodiments, the cooler 16 is configured by an evaporator of a vapor compression type refrigeration cycle device, but is not limited to this. The cooler 16 may be configured by, for example, a cooling device using a Peltier element that generates cold heat when energized.

In each of the embodiments, the heater 18 is configured by the heater core that radiates the cooling water of the heating device, but is not limited thereto. The heater 18 may be configured by, for example, an electric heater that generates heat when energized.

In each of the embodiments, a centrifugal blower is employed as the blower 14 having a structure in which the air suction direction and the air blowout direction are fixed in predetermined directions, but is not limited to this. The blower 14 may be composed of, for example, a cross-flow blower to which a stabilizer is fixed, an axial-flow blower employing an electric motor rotatable only in one direction, a piezo-type blower, or the like. Further, as the blower 14, a blower that can reverse the air suction direction and the air blowout direction may be employed.

In each of the embodiments, the humidity control device of the present disclosure is applied to the air conditioner 10 that adjusts the humidity in a room of a house or a vehicle. However, the application target of the humidity control device of the present disclosure is not limited to the above. The humidity control device of the present disclosure can be widely applied to various apparatuses used for equipment or facilities that require humidity control.

In the embodiments, it is needless to say that the elements configuring the embodiments are not necessarily essential except in the case where those elements are clearly indicated to be essential in particular, the case where those elements are considered to be obviously essential in principle, and the like.

In the embodiments, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments, when referring to the shape, positional relationship, and the like of a component and the like, the present disclosure is not limited to the shape, positional relationship, and the like, except for the case of being specifically specified, the case of being fundamentally limited to a specific shape, positional relationship, and the like, and the like.

According to the first aspect shown in a part or all of the above-described embodiments, the humidity control device has the mode switching unit configured to reverse the direction of air flow in the adsorber in a state where the air suction direction and the air blowout direction of the blower is maintained.

According to the second aspect, the humidity control device includes a casing in which the blower and the adsorber are housed and in which an air passage communicating with the ventilation path inside the adsorber is formed. The mode switching unit includes an adsorber displacement mechanism that displaces the adsorber so that the positions of the pair of ventilation surfaces change. The adsorber displacement mechanism displaces the adsorber to a position where one ventilation surface is on the upstream side of the other ventilation surface in the air flow at the adsorption mode, and at the desorption mode, the one ventilation surface is on the downstream side of the other ventilation surface.

As described above, the direction of air flow in the adsorber can be reversed by displacing the pair of ventilation surfaces of the adsorber, without a blower capable of reversing the air suction direction and the air blowout direction. According to the third aspect, the air passage of the humidity control device includes a cool air introduction passage for introducing the cool air to the adsorber, a warm air introduction passage for introducing the warm air to the adsorber, a humidified air outlet passage for sending the humidified air from the adsorber, and a dehumidified air outlet passage for leading out the dehumidified air from the adsorber. The adsorber has a side wall for forming a ventilation path. The adsorber displacement mechanism displaces the adsorber, in the adsorption mode, to a position where the cool air introduction passage and the dehumidified air outlet passage communicate with each other via the ventilation path and a communication between the warm air introduction passage and the humidified air outlet passage is cut off by the side wall. In the desorption mode, the adsorber displacement mechanism displaces the adsorber to a position where the warm air introduction passage and the humidified air outlet passage communicate with each other via the ventilation path, and a communication between the cool air introduction passage and the dehumidified air outlet passage is cut off by the side wall.

According to this, the side wall of the adsorber functions as a communication blocking unit that blocks communication between the warm air introduction passage and the humidified air outlet passage during the adsorption mode, and that blocks communication the cool air introduction passage and the dehumidified air outlet passage during the desorption mode. For this reason, it is possible to suppress an increase in the number of components in the humidity control device, as compared with a case where a communication blocking unit is configured by a separate member (for example, a door member).

According to the fourth aspect, the humidity control device includes a casing in which a blower and an adsorber are housed and in which an air passage communicating with a ventilation path inside the adsorber is formed. The mode switching unit includes a path switching mechanism that switches a ventilation path of the air flowing through the air passage. The path switching mechanism switches the ventilation path, in the adsorption mode, so that air flowing in the air passage flows into the adsorber from one ventilation surface and flows out from the other ventilation surface. In the desorption mode, the path switching mechanism switches the ventilation path so that air flowing in the air passage flows into the adsorber from the other ventilation surface and flows out from the one ventilation surface.

As described above, the direction of air flow in the adsorber is reversed by switching the ventilation path. Therefore, the air flow direction in the adsorber can be reversed without employing a blower capable of reversing the air suction direction and the air blowout direction.

According to the fifth aspect, a humidity control device includes a cooler that cools air flowing through an air passage and a heater that heats air flowing through the air passage. The path switching mechanism switches the ventilation path so that air flows in the order of the cooler, the adsorber, and the heater in the adsorption mode, and switches the ventilation path so that air flows in the order of the heater, the adsorber, and the cooler in the desorption mode.

According to this, it is possible to suppress the temperature of the dehumidifying air generated in the adsorption mode from being excessively low, or to suppress the temperature of the humidifying air generated in the desorption mode from being excessively high. That is, it is possible to restrict the temperature of the space to be controlled in humidity from changing more than necessary due to the humidity adjustment by the humidity control device.

According to the sixth aspect, the adsorber of the humidity control device has a pair of ventilation surfaces through which air flows in or out, and is arranged so that the pair of ventilation surfaces straddle both the cool air passage and the warm air passage. The adsorber displacement mechanism is configured to displace the adsorber to a position where the cool air and the warm air flowing from one ventilation surface flow out of the other ventilation surface, and to a position where the cool air and the warm air flowing from the other ventilation surface flow into the one ventilation surface.

According to the seventh aspect, the humidity control device includes a pair of partition portions that partition a part of the air passage into a cool air passage and a warm air passage. One of the partition portions is provided on the one ventilation surface, and the other partition portion is provided on the other ventilation surface. The one ventilation surface is divided into a first ventilation portion and a second ventilation portion by the one partition portion. The other ventilation surface is divided into a third ventilation portion and a fourth ventilation portion by the other partition portion. The adsorber displacement mechanism displaces the adsorber between a position where the cool air flowing in from the first ventilation portion flows out of the third ventilation portion and a position where the warm air flowing in from the third ventilation portion flows out of the first ventilation portion.

According to the eighth aspect, the adsorber of the humidity control device has a pair of ventilation surfaces through which air flows in or out. In the adsorber, the pair of ventilation surfaces are arranged across both the cool air passage and the warm air passage so that a part of the one ventilation surface becomes a cool air inflow surface and the rest becomes a warm air outflow surface, and a part of the other ventilation surface becomes a cool air outflow surface, and the rest becomes a warm air inflow surface.

According to the ninth aspect, a humidity control device includes a driving mechanism that moves an adsorbent. The driving mechanism is configured to move at least a part of the adsorbent positioned on the side of the cool air passage to the side of the warm air passage and to move at least a part of the adsorbent positioned on the side of the warm air passage to the side of the cool air passage.

According to this, the adsorbent that has adsorbed moisture on the cool air passage side is moved to the warm air passage side, and the adsorbent that has desorbed moisture on the warm air passage side is moved to the cool air passage side, so as to continuously generate dehumidified air and humidified air.

According to the tenth aspect, the air suction direction and the air blowout direction are fixed in predetermined directions in the blower of the humidity control device. The humidity control device according to the present disclosure can appropriately exert the humidity adjustment function while the air suction direction and the air blowout direction of the blower are fixed in predetermined directions.

What is claimed is:

1. A humidity control device configured to control a humidity of a target space with an adsorbent having a moisture adsorption and desorption function, the humidity control device comprising:
an adsorber including the adsorbent;
a blower configured to supply air to the adsorber;
a mode switching unit configured to set a desorption mode in which moisture adsorbed by the adsorbent is desorbed to humidify air or an adsorption mode in which moisture is adsorbed by the adsorbent to dehumidify air; and
a casing housing the blower and the adsorber and having an air passage communicated with a ventilation path inside the adsorber, wherein
the air passage includes
a cool air introduction passage to introducing cool air to the adsorber,
a warm air introduction passage to introduce warm air to the adsorber,
a humidified air outlet passage to guide humidified air from the adsorber, and
a dehumidified air outlet passage to guide dehumidified air from the adsorber,
the adsorber has
a pair of ventilation surfaces through which air flows in or out, and
a side wall that forms the ventilation path,
the mode switching unit is configured to reverse an air flow direction in the adsorber such that one of the pair of ventilation surfaces serving as an air inflow surface in the adsorption mode is used for an air outflow surface in the desorption mode and that the other of the pair of ventilation surfaces serving as an air outflow surface in the adsorption mode becomes an air inflow surface in the desorption mode in a state where an air suction direction and an air blowout direction of the blower is maintained,
the mode switching unit includes an adsorber displacement mechanism configured to displace the adsorber to change positions of the pair of ventilation surfaces,
the adsorber displacement mechanism displaces the adsorber, during the adsorption mode, to place the one of the ventilation surfaces at a position upstream of the other of the ventilation surfaces in the air flow direction, such that the cool air introduction passage and the dehumidified air outlet passage communicate with each other via the ventilation path, and that the side wall shuts off communication between the warm air introduction passage and the humidified air outlet passage, and
the adsorber displacement mechanism displaces the adsorber, during desorption mode, to place the one of the ventilation surfaces at a position downstream of the other of the ventilation surfaces in the air flow direction, such that the warm air introduction passage and the humidified air outlet passage communicate with each other via the ventilation path, and that the side wall shuts off communication between the cool air introduction passage and the dehumidified air outlet passage.

2. A humidity control device configured to control a humidity of a target space with an adsorbent having a moisture adsorption and desorption function, the humidity control device comprising:
an adsorber including the adsorbent;
a blower configured to supply air to the adsorber;
a casing housing the blower and the adsorber and having an air passage communicated with a ventilation path inside the adsorber; and
an adsorber displacement mechanism configured to displace the adsorber, wherein
a part of the air passage is partitioned into a cool air passage through which cool air flows and a warm air passage through which warm air flows,
the adsorber has a pair of ventilation surfaces through which air flows in or out, and is arranged so that the pair of ventilation surfaces straddle both the cool air passage and the warm air passage, and
the adsorber displacement mechanism is configured to displace the adsorber to a position where cool air and warm air flowing in from one of the ventilation surfaces flow out from the other of the ventilation surfaces or a position where cool air and warm air flowing in from the other of the ventilation surfaces flow out of the one of the ventilation surfaces.

3. The humidity control device according to claim 2, further comprising:
a pair of partition walls that partition a part of the air passage into the cool air passage and the warm air passage,
one of the partition walls is provided adjacent to the one of the ventilation surfaces, and the other of the partition walls is provided adjacent to the other of the ventilation surfaces,
the one of the ventilation surfaces is divided into a first ventilation portion and a second ventilation portion by the one of the partition walls,
the other of the ventilation surfaces is divided into a third ventilation portion and a fourth ventilation portion by the other of the partition walls, and
the adsorber displacement mechanism is configured to displace the adsorber at a position where cool air flowing in from the first ventilation portion flows out of the third ventilation portion and warm air flowing in from the second ventilation portion flows out of the fourth ventilation portion, or at a position where cool air flowing in from the fourth ventilation portion flows out of the second ventilation portion and warm air flowing in from the third ventilation portion flows out of the first ventilation portion.

4. The humidity control device according to claim 1, wherein the air suction direction and the air blowout direction of the blower are fixed in predetermined directions.
